(19) United States
(12) Patent Application Publication
(10) Pub. No.: US 2023/0345195 A1
(43) Pub. Date: Oct. 26, 2023

(54) SIGNAL PROCESSING APPARATUS, METHOD, AND PROGRAM

(71) Applicant: SONY GROUP CORPORATION, TOKYO (JP)

(72) Inventors: HIROYUKI HONMA, TOKYO (JP); TORU CHINEN, TOKYO (JP)

(21) Appl. No.: 18/001,719

(22) PCT Filed: Jun. 8, 2021
(86) PCT No.: PCT/JP2021/021663

§ 371 Date: Dec. 14, 2022

(30) Foreign Application Priority Data
Jun. 22, 2020 (JP) 2020-106972

(51) Int. Cl. H04S 7/00

(52) U.S. Cl. CPC H04S 7/302; H04S 2420/01; H04S 2420/07

(57) ABSTRACT

The present technique pertains to a signal processing apparatus, a method, and a program that enable even a low-cost apparatus to perform high-quality audio reproduction. The signal processing apparatus includes an obtainment unit that obtains a first audio signal, first band expansion information for band expansion of the first audio signal, and second band expansion information for band expansion of a second audio signal obtained by performing predetermined signal processing on the first audio signal, a selection unit that selects which of the first band expansion information and the second band expansion information to perform band expansion on the basis of, and a band expansion unit that, on the basis of the selected first band expansion information or second band expansion information and the first audio signal or the second audio signal performs band expansion, and generates a third audio signal. The present technique can be applied to a signal processing apparatus.

### TECHNICAL FIELD

The present technique pertains to a signal processing apparatus, a method, and a program, and particularly pertains to a signal processing apparatus, a method, and a program that enable even a low-cost apparatus to perform high-quality audio reproduction.

### BACKGROUND ART

In the past, an object audio technique is used in video, games, etc., and an encoding method that can handle object audio has also been developed. Specifically, for example, an MPEG (Moving Picture Experts Group)-H Part 3:3D audio standard, which is an international standard, is known (for example, refer to NPL 1).

With such an encoding method, it is possible to, together with a conventional two-channel stereo method or a multi-channel stereo method having 5.1 channels, etc., handle a moving sound source, etc., as an independent audio object (hereinafter, may be simply referred to as an object), and encode position information for the object as metadata together with signal data for the audio object.

As a result, it is possible to perform reproduction in various viewing/listening environments having differing numbers and dispositions of speakers. In addition, it is possible to easily process sound from a specific sound source at a time of reproduction, such as volume adjustment for sound from the specific sound source or adding effects to the sound from the specific sound source, which have been difficult with conventional encoding methods.

With such an encoding method, decoding with respect to a bitstream is performed on a decoding side, and metadata that includes an object signal which is an audio signal for the object position information and object position information indicating the position of the object in a space is obtained.

On the basis of the object position information, rendering processing for rendering the object signal at each of a plurality of virtual speakers that is virtually disposed in the space is performed. For example, in the standard in NPL 1, a method referred to as three-dimensional VBAP (Vector Based Amplitude Panning) (hereinafter simply referred to as VBAP) is used in the rendering processing.

In addition, when virtual speaker signals corresponding to respective virtual speakers is obtained by the rendering processing, HRTF (Head Related Transfer Function) processing is performed on the basis of the virtual speaker signals. In this HRTF processing, an output audio signal for causing sound to be outputted from actual headphones or a speaker as if sound is reproduced from the virtual speakers is generated.

In a case of actually reproducing such object audio, reproduction based on the virtual speaker signals is performed when it is possible to dispose many actual speakers in the space. In addition, when it is not possible to dispose many speakers and object audio is reproduced with a small number of speakers such as with headphones or a soundbar, reproduction based on the output audio signal described above is performed.

In contrast, in recent years, due to a drop in storage prices or a change to broadband networks, generally-called high-resolution sound sources having a sampling frequency of 96 kHz or more, in other words high-resolution sound sources, have come to be enjoyed.

With the encoding method described in NPL 1, it is possible to use a technique such as SBR (Spectral Band Replication) as a technique for efficiently encoding a high-resolution sound source.

For example, on the encoding side in SBR, a high-range component for a spectrum is not encoded, and average amplitude information for a high-range sub-band signal is only encoded and transmitted for the number of high-range sub bands.

On the decoding side, a final output signal that includes a low-range component and a high-range component is generated on the basis of a low-range sub-band signal and the average amplitude information for the high range. As a result, it is possible to realize higher-quality audio reproduction.

With such a technique, in a case where a person is insensitive to phase change for a high-range signal component and an outline for a frequency envelope therefor is close to the original signal, the hearing characteristic of not being able to perceive the difference therebetween is utilized. Such a technique is widely known as a typical band expansion technique.

### CITATION LIST

### Non-Patent Literature

### [Npl 1]

INTERNATIONAL STANDARD ISO/IEC 23008-3 Second edition 2019-02 Information technology - High efficiency coding and media delivery in heterogeneous environments - Part 3: 3D audio

### SUMMARY

### Technical Problem

Incidentally, in a case of performing band expansion in combination with rendering processing or HRTF processing for object audio described above, the rendering processing or the HRTF processing is performed after band expansion processing is performed on the object signal for each object.

In this case, because the band expansion processing is independently performed for the numbers of objects, the processing load, in other words the amount of calculations gets large. In addition, after the band expansion processing, the processing load further increases because rendering processing or HRTF processing is performed on a signal having a higher sampling frequency obtained by the band expansion.

Accordingly, a low-cost apparatus such an apparatus having a low-cost processor or battery, in other words an apparatus having low arithmetic processing capability or an apparatus having low battery capacity, cannot perform band expansion, and as a result cannot perform high-quality audio reproduction.

The present technique is made in the light of such a situation and enables high-quality audio reproduction to be performed even with a low-cost apparatus.

### Solution to Problem

A signal processing apparatus according to one aspect of the present technique includes an obtainment unit that obtains a first audio signal, first band expansion information for band expansion of the first audio signal, and second band expansion information for band expansion of a second audio signal obtained by performing predetermined signal processing on the first audio signal, a selection unit that selects which of the first band expansion information and the second band expansion information to perform band expansion on the basis of, and a band expansion unit that, on the basis of the selected first band expansion information or second band expansion information and the first audio signal or the second audio signal, performs band expansion and generates a third audio signal.

A signal processing method or a program according to one aspect of the present technique includes the steps of obtaining a first audio signal, first band expansion information for band expansion of the first audio signal, and second band expansion information for band expansion of a second audio signal obtained by performing predetermined signal processing on the first audio signal, selecting which of the first band expansion information and the second band expansion information to perform band expansion on the basis of, and on the basis of the selected first band expansion information or second band expansion information and the first audio signal or the second audio signal, performing band expansion and generating a third audio signal.

In one aspect of the present technique a first audio signal, first band expansion information for band expansion of the first audio signal, and second band expansion information for band expansion of a second audio signal obtained by performing predetermined signal processing on the first audio signal are obtained, which of the first band expansion information and the second band expansion information to perform band expansion on the basis of is selected, and on the basis of the selected first band expansion information or second band expansion information and the first audio signal or the second audio signal, band expansion is performed and a third audio signal is generated.

### BRIEF DESCRIPTION OF DRAWINGS

FIG. 1 is a view for describing generation of an output audio signal.

FIG. 2 is a view for describing VBAP.

FIG. 3 is a view for describing HRTF processing.

FIG. 4 is a view for describing band expansion processing.

FIG. 5 is a view for describing band expansion processing.

FIG. 6 is a view that illustrates an example of a configuration of a signal processing apparatus.

FIG. 7 is a view that illustrates a syntax example for an input bitstream.

FIG. 8 is a flow chart for describing signal generation processing.

FIG. 9 is a view that illustrates an example of a configuration of a signal processing apparatus.

FIG. 10 is a view that illustrates an example of a configuration of an encoder.

FIG. 11 is a flow chart for describing encoding processing.

FIG. 12 is a view that illustrates an example of a configuration of a signal processing apparatus.

FIG. 13 is a flow chart for describing signal generation processing.

FIG. 14 is a view that illustrates an example of a configuration of a signal processing apparatus.

FIG. 15 is a view that illustrates an example of a configuration of a signal processing apparatus.

FIG. 16 is a view that illustrates an example of a configuration of a computer.

### DESCRIPTION OF EMBODIMENTS

With reference to the drawings, description is given below regarding embodiments to which the present technique has been applied.

### First Embodiment

### <Present Technique>

The present technique performs transmission after multiplexing, with a bitstream, high-range information which is for band expansion processing having a virtual speaker signal or an output audio signal set as a target in advance and is separate from high-range information for band expansion processing directly obtained from an object signal before encoding.

As a result, it is possible to perform decoding processing, rendering processing, or virtualization processing, which have high processing load, with a low sampling frequency and subsequently perform band expansion processing on the basis of the high-range information, and it is possible to reduce an overall amount of calculations. As a result, it is possible to perform high-quality audio reproduction based on an output audio signal having a higher sampling frequency, even with a low-cost apparatus.

Firstly, description is given regarding typical processing performed when performing decoding (decoding) on a bitstream obtained by an encoding method for an MPEG-H Part 3:3D audio standard and generating an output audio signal for object audio.

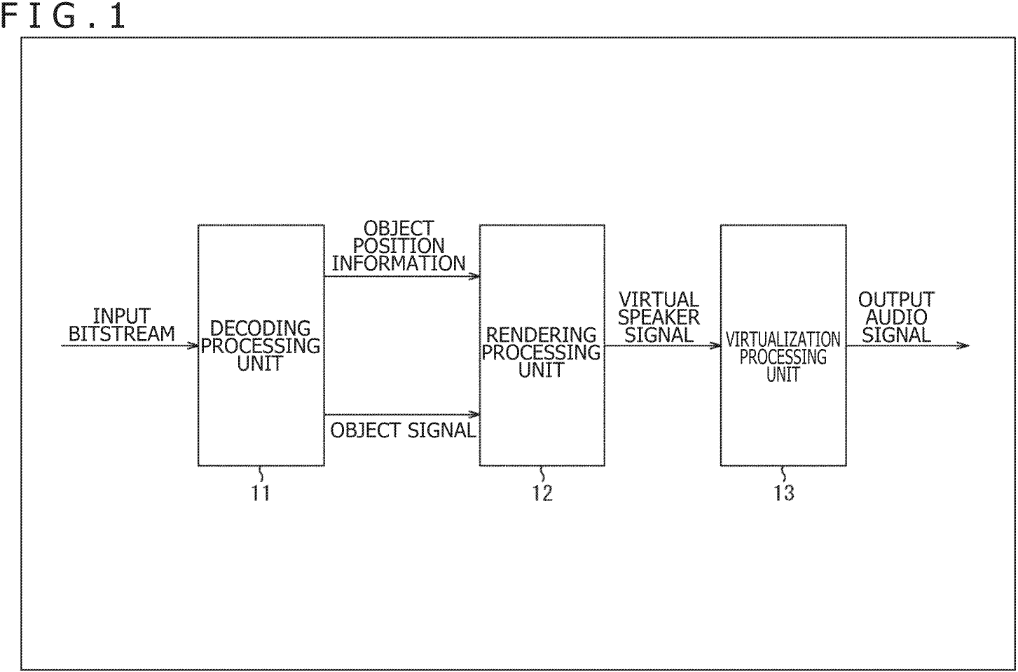

For example, as illustrated in FIG. 1, when an input bitstream obtained by encoding (encoding) is inputted to a decoding processing unit 11, demultiplexing and decoding processing is performed on the input bitstream.

Metadata, which includes an object signal which is an audio signal for reproducing sound from an object (audio object) that constitutes content and object position information indicating a position in a space for the object position information, is obtained by the decoding processing.

Subsequently, in a rendering processing unit 12 and on the basis of the object position information included in the metadata, rendering processing for rendering the object signal to virtual speakers virtually disposed in the space is performed and virtual speaker signals for reproducing sound to be outputted from respective virtual speakers are generated.

Furthermore, in a virtualization processing unit 13, virtualization processing is performed on the basis of the virtual speaker signals for respective virtual speakers, and an output audio signal for causing sound to be output from a reproduction apparatus such as headphones mounted by a user or a speaker disposed in real space is generated.

Virtualization processing is processing for generating an audio signal for realizing audio reproduction as if reproduction is performed with a different channel configuration to a channel configuration in a real reproduction environment.

For example, in this example virtualization processing is processing for generating an output audio signal for realizing audio reproduction as if sound is outputted from each virtual speaker, irrespective of sound actually being outputted from a reproduction apparatus such as headphones.

Virtualization processing may be realized by any technique, but the description continues below with the assumption that HRTF processing is performed as virtualization processing.

If sound is outputted from actual headphones or a speaker on the basis of an output audio signal obtained by virtualization processing, it is possible to realize audio reproduction as if sound is reproduced from a virtual speaker. Note that a speaker actually disposed in a real space is in particular referred to below as a real speaker.

In a case of reproducing such object audio, when many real speakers can be disposed in a space, it is possible to reproduce, by the real speakers, output from the rendering processing unchanged.

In contrast to this, when it is not possible to dispose many real speakers in a space, HRTF processing is performed and then reproduction is performed using a small number of real speakers, such as with headphones or a soundbar. Typically, reproduction is often performed using headphones or a small number of real speakers.

Here, further description is given regarding typical rendering processing and HRTF processing.

For example, at a time of rendering, rendering processing with a predetermined method such as the above-described VBAP is performed. VBAP is one rendering technique that is typically referred to as panning, and performs rendering by distributing gain to, from among virtual speakers present on a sphere surface having a user position as an origin, the three virtual speakers closest to an object present on the same sphere surface.

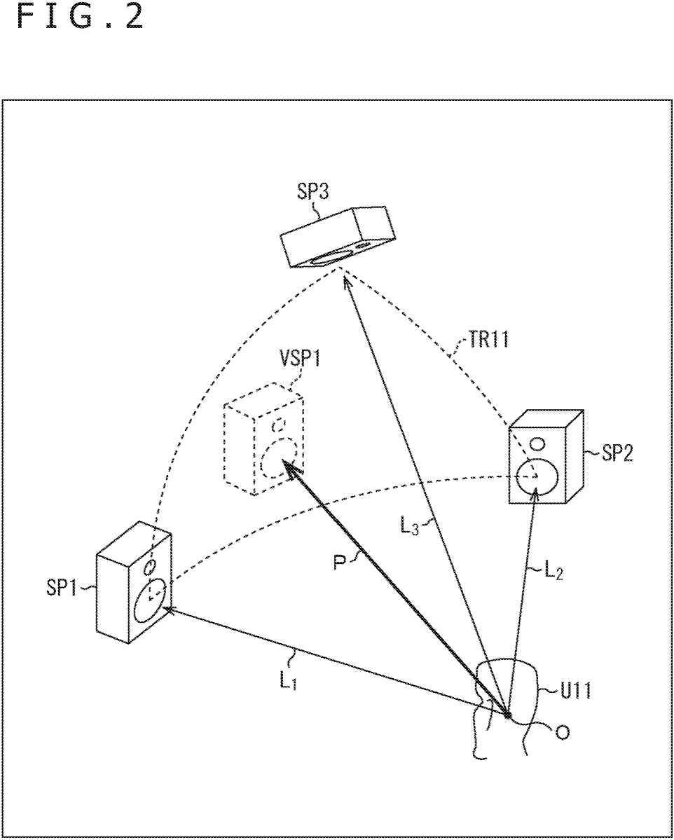

For example, as illustrated in FIG. 2, it is assumed that a user U11 who is a listener is present in a three-dimensional space, and three virtual speakers SP1 through SP3 are disposed in front of the user U11.

Here, letting the position of the head of the user U11 be an origin O, it is assumed that the virtual speakers SP1 through SP3 are positioned on the surface of a sphere centered on the origin O.

It is now considered that an object is present in a region TR11 surrounded by the virtual speakers SP1 through SP3 on the sphere surface, and a sound image is caused to be localized to a position VSP1 for the object.

In such a case, in VBAP, the gain for the object is distributed to the virtual speakers SP1 through SP3 which are in the vicinity of the position VSP1.

Specifically, in a three-dimensional coordinate system having the origin O as a reference (origin), it is assumed that the position VSP1 is represented by a three-dimensional vector P having the origin O as a start point and the position VSP1 as an end point.

In addition, letting three-dimensional vectors having the origin O as a start point and positions of the virtual speakers SP1 through SP3 as respective end points be vectors L₁ through L₃, the vector P can be represented by a linear combination of the vectors L₁ through L₃ as indicated in the following formula (1).

$$\text{P} = {\text{g}}_{1} {\text{L}}_{1} + {\text{g}}_{2} {\text{L}}_{2} + {\text{g}}_{3} {\text{L}}_{3} \qquad \text{[Math. 1]}$$

Here, coefficients g₁ through g₃ which are multiplied with the vectors L₁ through L₃ in formula (1) are calculated, and if the coefficients g₁ through g₃ are made to be the gain for sound respectively outputted from the virtual speakers SP1 through SP3, it is possible to localize the sound image to the position VSP1.

For example, letting a vector having the coefficients g₁ through g₃ as elements be g₁₂₃ = [g_{1,} g_{2,} g_{3]} and a vector having the vectors L₁ through L₃ as elements be L₁₂₃ = [L₁, L₂, L₃], it is possible to transform the formula (1) described above to obtain the following formula (2).

$${\text{g}}_{123} = {\text{P}}^{\text{T}} {\text{L}}_{123}^{- 1} \qquad \text{[Math. 2]}$$

If, using the coefficients g₁ through g₃ obtained by calculating the formula (2) as above as gain, sound based on an object signal is outputted from each of the virtual speakers SP1 through SP3, it is possible to localize the sound image to the position VSP1.

Note that, because the position at which each of the virtual speakers SP1 through SP3 is disposed is fixed and information indicating the positions of these virtual speakers is known, it is possible to obtain in advance L₁₂₃⁻¹ which is an inverse matrix.

The triangular region TR11 surrounded by the three virtual speakers on the sphere surface illustrated in FIG. 2 is referred to as a mesh. By configuring a plurality of meshes by combining many virtual speakers disposed in a space, it is possible to localize sound for an object to an optionally defined position in the space.

In such a manner, when virtual speaker gain is obtained for each object, it is possible to obtain a virtual speaker signal for each virtual speaker by calculating the following formula (3).

$$\begin{matrix}\left[\begin{matrix}\text{SP} \left(0 , \text{t}\right) \\ \text{SP} \left(1 , \text{t}\right) \\ ⋮ \\ \text{SP} \left(\text{M} - 1 , \text{t}\right)\end{matrix}\right] = \\ \left[\begin{matrix}\text{G} \left(0 , 0\right) & \text{[Math. 3]} \left(0 , 1\right) & ⋯ & \text{G} \left(0 , \text{N} - 1\right) \\ \text{G} \left(1 , 0\right) & \text{G} \left(1 , 1\right) & ⋯ & \text{G} \left(1 , \text{N} - 1\right) \\ ⋮ & ⋮ & & ⋮ \\ \text{G} \left(\text{M} - 1 , 0\right) & \text{G} \left(\text{M} - 1 , 1\right) & ⋯ & \text{G} \left(\text{M} - 1 , \text{N} - 1\right)\end{matrix}\right] \left[\begin{matrix}\text{S} \left(0 , \text{t}\right) \\ \text{S} \left(1 , \text{t}\right) \\ ⋮ \\ \text{S} \left(\text{N} - 1 , \text{t}\right)\end{matrix}\right]\end{matrix}$$

Note that SP(m, t) in formula (3) indicates a virtual speaker signal at a time t for an mth (however, m = 0, 1, ..., M-1) virtual speaker from among M virtual speakers. In addition, S(n, t) in formula (3) indicates an object signal at a time t for an nth (however, n = 0, 1, ..., N-1) object from among N objects.

Furthermore, G(m, n) in formula (3) indicates a gain which is multiplied with the object signal S(n, t) for the nth object signal and is for obtaining the virtual speaker signal SP(m, t) for the mth virtual speaker signal. In other words, the gain G(m, n) indicates a gain which is obtained by the formula (2) described above and is distributed to the mth virtual speaker for the nth object.

The rendering processing is processing in which a calculation for the formula (3) most applies to the computational cost. In other words, it is processing for which a calculation for formula (3) has the largest amount of calculations.

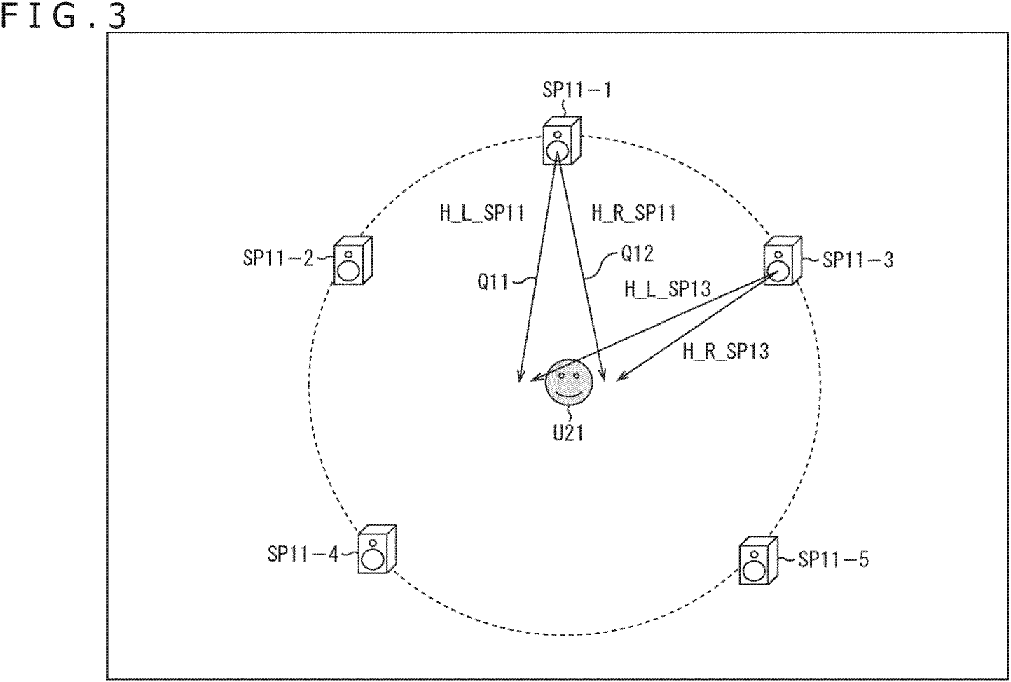

Next, with reference to FIG. 3, description is given regarding an example of HRTF processing which is performed in a case of reproducing, with headphones or a small number of real speakers, sound based on virtual speaker signals obtained by calculating formula (3). Note that FIG. 3 is an example in which virtual speakers are disposed on a two-dimensional horizontal surface in order to simplify the description.

In FIG. 3, five virtual speakers SP11-1 through SP11-5 are disposed lined up on a circle in a space. The virtual speakers SP11-1 through SP11-5 are simply referred to as virtual speakers SP11 in a case where it is not particularly necessary to distinguish the virtual speakers SP11-1 through SP11-5.

In addition, in FIG. 3, a user U21 who is a listener is positioned at a position surrounded by the five virtual speakers SP11, in other words at a center position of a circle on which the virtual speakers SP11 are disposed. Accordingly, in HRTF processing, an output audio signal for realizing audio reproduction as if the user U21 is hearing sound outputted from each of the virtual speakers SP11 is generated.

In particular, in this example it is assumed that the position where the user U21 is present is a listening position, and sound based on virtual speaker signals obtained by rendering to each of the five virtual speakers SP11 is reproduced using headphones.

In such a case, for example, sound outputted (radiated) from the virtual speaker SP11-1 on the basis of a virtual speaker signal passes through a route indicated by an arrow Q11 and reaches the ear drum in the left ear of the user U21. Accordingly, characteristics of the sound outputted from the virtual speaker SP11-1 should change due to a spatial transfer characteristic for from the virtual speaker SP11-1 to the left ear of the user U21, the shape of the face or ears of the user U21, reflection absorption characteristics, etc.

Accordingly, if a transfer function H_L_SP11 that takes into account the spatial transfer characteristic for from the virtual speaker SP11-1 to the left ear of the user U21, the shape of the face or ears of the user U21, reflection absorption characteristics, etc. is convolved with the virtual speaker signal for the virtual speaker SP11-1, it is possible to obtain an output audio signal for reproducing sound from the virtual speaker SP11-1 that should be heard by the left ear of the user U21.

Similarly, for example, sound outputted (radiated) from the virtual speaker SP11-1 on the basis of a virtual speaker signal passes a route indicated by an arrow Q12 and reaches the ear drum in the right ear of the user U21. Accordingly, if a transfer function H_R_SP11 that takes into account the spatial transfer characteristic for from the virtual speaker SP11-1 to the right ear of the user U21, the shape of the face or ears of the user U21, reflection absorption characteristics, etc. is convolved with the virtual speaker signal for the virtual speaker SP11-1, it is possible to obtain an output audio signal for reproducing sound from the virtual speaker SP11-1 that should be heard by the right ear of the user U21.

From this, when finally reproducing, with headphones, sound based on virtual speaker signals for the five virtual speakers SP11, for a left channel, it is sufficient if a left-ear transfer function for each virtual speaker is convolved with a respective virtual speaker signal and the signals obtained as a result thereof are added together to make an output audio signal for the left channel.

Similarly, for a right channel, it is sufficient if a right-ear transfer function for each virtual speaker is convolved with a respective virtual speaker signal and the signals obtained as a result thereof are added together to make an output audio signal for the right channel.

Note, in a case where a reproduction apparatus used in reproduction is a real speaker instead of headphones, HRTF processing similar to a case for headphones is performed. However, because sound from the speaker reaches both of the left and right ears for a user according to spatial propagation, processing that considers crosstalk is performed. Such processing is referred to as trans-aural processing.

Typically, letting a left-ear output audio signal, in other words a left-channel output audio signal, that has been subjected to frequency representation be L(ω) and a right-ear output audio signal, in other words a right-channel output audio signal, that has been subjected to frequency representation be R(ω), L(w) and R(w) can be obtained by calculating the following formula (4).

$$\begin{matrix}\left[\begin{matrix}\text{L} \left(\text{ω}\right) \\ \text{R} \left(\text{ω}\right)\end{matrix}\right] = \\ \left[\begin{matrix}\text{H\_L} \left(0 , \text{ω}\right) & \text{[Math. 4]} \left(1 , \text{ω}\right) & ⋯ & \text{H\_L} \left(\text{M} - 1 , \text{ω}\right) \\ \text{H\_R} \left(0 , \text{ω}\right) & \text{H\_R} \left(1 , \text{ω}\right) & ⋯ & \text{H\_R} \left(\text{M} - 1 , \text{ω}\right)\end{matrix}\right] \left[\begin{matrix}\text{SP} \left(0 , \text{ω}\right) \\ \text{SP} \left(1 , \text{ω}\right) \\ ⋮ \\ \text{SP} \left(\text{M} - 1 , \text{ω}\right)\end{matrix}\right]\end{matrix}$$

Note that ω in formula (4) indicates a frequency, and SP(m, ω) indicates a virtual speaker signal for the frequency ω for the mth (however, m = 0, 1, ..., M-1) virtual speaker from among the M virtual speakers. The virtual speaker signal SP(m, ω) can be obtained by subjecting the above-described virtual speaker signal SP(m, t) to a time-frequency conversion.

In addition, H_L(m, ω) in formula (4) indicates a left-ear transfer function that is multiplied with the virtual speaker signal SP(m, ω) for the mth virtual speaker and is for obtaining the left-channel output audio signal L(ω). Similarly, H_R(m, ω) indicates a right-ear transfer function.

In a case where the transfer function H_L(m, ω) or the transfer function H_R(m, ω) for the HRTF is represented as a time-domain impulse response, a length of at least approximately one second is necessary. Accordingly, for example, in a case where a sampling frequency for a virtual speaker signal is 48 kHz, a convolution with 48000 taps must be performed, and a large amount of calculations will be necessary even if a highspeed arithmetic method that uses an FFT (Fast Fourier Transform) is used to convolve the transfer function.

In a case of generating an output audio signal by performing decoding processing, rendering processing, and HRTF processing as above, and using headphones or a small number of real speakers to reproduce object audio, a large amount of calculations will be necessary. In addition, this amount of calculations also proportionally increases when the number of objects increases.

Next, description is given regarding band expansion processing.

In typical band expansion processing, in other words in SBR, on the encoding side, a high-range component for the spectrum of an audio signal is not encoded, and average amplitude information for a high-range sub-band signal for a high-range sub band that is a high-range frequency band is encoded for the number of high-range sub bands and transmitted to the decoding side.

In addition, on the decoding side, a low-range sub-band signal, which is an audio signal obtained by decoding processing (decoding), is normalized by the average amplitude thereof, and subsequently the normalized signal is copied (copied) to the high-range sub band. The signal obtained as a result is multiplied by the average amplitude information for each high-range sub band and set to a high-range sub-band signal, the low-range sub-band signal and the high-range sub-band signal are subjected to sub band synthesis, and set to a final output audio signal.

By such band expansion processing, for example, it is possible to perform audio reproduction for a high-resolution sound source having a sampling frequency of 96 kHz or more.

However, for example, in a case of processing a signal for which the sampling frequency is 96 kHz in object audio, differing from typical stereo audio, rendering processing or HRTF processing is performed on a 96 kHz object signal obtained by decoding, regardless of whether band expansion processing such as SBR is to be performed. Accordingly, in a case where there is a large number of objects or number of virtual speakers, the computational cost for processing for these becomes enormous, and a high-performance processor and high power consumption becomes necessary.

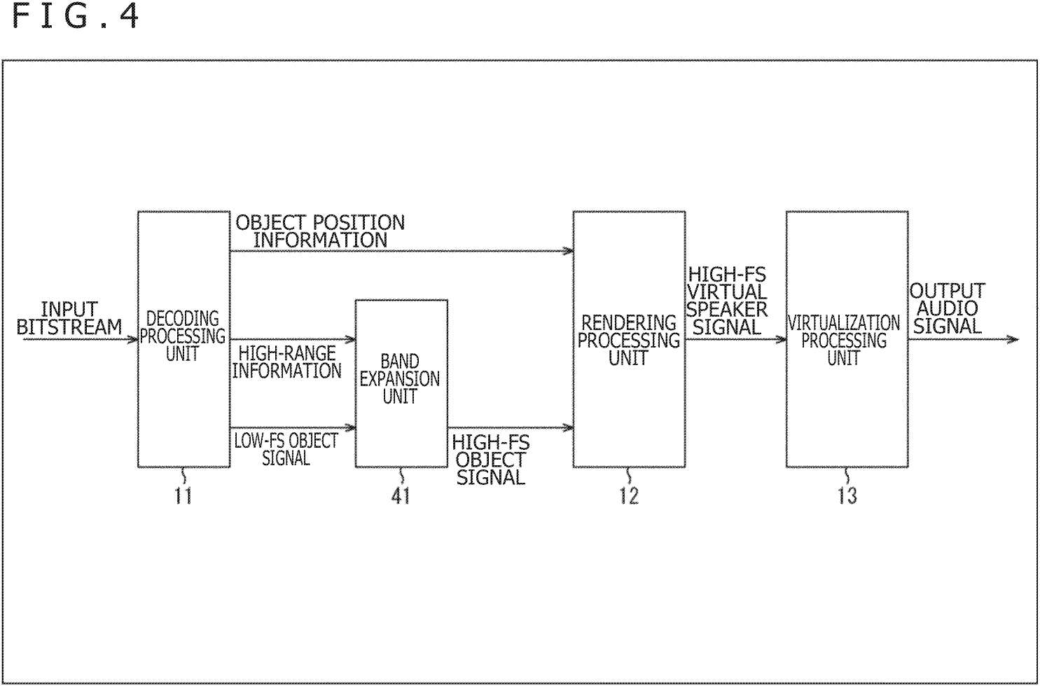

Here, with reference to FIG. 4, description is given regarding an example of processing to be performed in a case where a 96 kHz output audio signal is obtained through band expansion for object audio. Note that, in FIG. 4, the same reference sign is added to portions corresponding to the case in FIG. 1, and description thereof is omitted.

When an input bitstream is supplied, demultiplexing and decoding processing is performed by the decoding processing unit 11, and an object signal as well as object position information and high-range information for the object, which are obtained as a result, are outputted.

For example, the high-range information is average amplitude information for a high-range sub-band signal obtained from an object signal before encoding.

In other words, the high-range information band expansion information that is for band expansion corresponds to an object signal which is obtained by decoding processing and indicates the magnitude of each sub-band component on a high-range side for the object signal before encoding, which has a higher sampling frequency. Note that, because description is given with SBR as an example, average amplitude information for a high-range sub-band signal is used as band expansion information, but band expansion information for band expansion processing may be anything, such as a representative value for the amplitude or information indicating a shape of a frequency envelope, for each sub band on the high-range side of an object signal before encoding.

In addition, an object signal obtained through decoding processing is, for example, assumed to have a sampling frequency of 48 kHz here, and such an object signal may be referred to below as a low-FS object signal.

After decoding processing, in a band expansion unit 41, band expansion processing is performed on the basis of the high-range information and the low-FS object signal, and an object signal having a higher sampling frequency is obtained. In this example, it is assumed that, for example, an object signal having a sampling frequency of 96 kHz is obtained by the band expansion processing, and such an object signal may be referred to below as a high-FS object signal.

In addition, in the rendering processing unit 12, rendering processing is performed on the basis of the object position information obtained by the decoding processing and the high-FS object signal obtained by the band expansion processing. In particular, a virtual speaker signal having a sampling frequency of 96 kHz is obtained by the rendering processing in this example, and such a virtual speaker signal may be referred to below as a high-FS virtual speaker signal.

Furthermore, subsequently in the virtualization processing unit 13, virtualization processing such as HRTF processing is performed on the basis of the high-FS virtual speaker signal, and an output audio signal having a sampling frequency of 96 kHz is obtained.

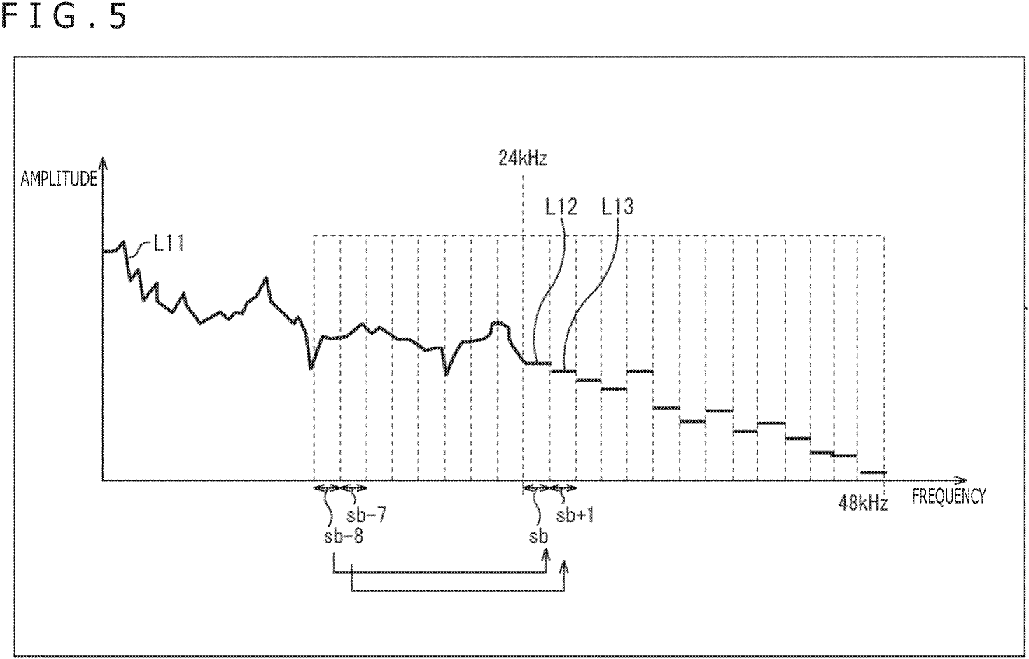

Here, with reference to FIG. 5, description is given regarding typical band expansion processing.

FIG. 5 illustrates frequency and amplitude characteristics for a predetermined object signal. Note that, in FIG. 5, the vertical axis indicates amplitude (power), and the horizontal axis indicates frequency.

For example, broken line L11 indicates frequency and amplitude characteristics for a low-FS object signal supplied to the band expansion unit 41. This low-FS object signal has a sampling frequency of 48 kHz, and the low-FS object signal does not include a signal component having a frequency band of 24 kHz or more.

Here, for example, the frequency band up to 24 kHz is divided into a plurality of low-range sub bands including a low-range sub band sb-8 through a low-range sub band sb-1, and a signal component for each of these low-range sub bands is a low-range sub-band signal. Similarly, the frequency band for from 24 to 48 kHz is divided into a high-range sub band sb through a high-range sub band sb+13, and a signal component for each of these high-range sub bands is a high-range sub-band signal.

In addition, for each of the high-range sub band sb through the high-range sub band sb+13, high-range information indicating the average amplitude information for these high-range sub bands is supplied to the band expansion unit 41.

For example, in FIG. 5, a straight line L12 indicates average amplitude information supplied as high-range information for the high-range sub band sb, and a straight line L13 indicates average amplitude information supplied as high-range information for the high-range sub band sb+1.

In the band expansion unit 41, the low-range sub-band signal is normalized by the average amplitude value for the low-range sub-band signal, and a signal obtained by normalization is copied (mapped) to the high-range side. Here, a low-range sub band which is a copy source and a high-range sub band that is a copy destination for this low-range sub band are predefined according to an expanded frequency band, etc.

For example, a low-range sub-band signal for the low-range sub band sb-8 is normalized, and a signal obtained by the normalization is copied to the high-range sub band sb.

More specifically, modulation processing is performed on the signal resulting from the normalization of the low-range sub-band signal for the low-range sub band sb-8, and a conversion to a signal for a frequency component for the high-range sub band sb is performed.

Similarly, for example, a low-range sub-band signal for the low-range sub band sb-7 is normalized and then copied to the high-range sub band sb+1.

When a low-range sub-band signal that has been normalized in such a manner is copied (mapped) to a high-range sub band, average amplitude information indicated by the high-range information for a respective high-range sub band is multiplied with the copied signal for the respective high-range sub band, and a high-range sub-band signal is generated.

For the high-range sub band sb, for example, average amplitude information indicated by the straight line L12 is multiplied with a signal obtained by copying a result of normalizing the low-range sub-band signal for the low-range sub band sb-8 to the high-range sub band sb, and a result of the multiplication is set to the high-range sub-band signal for the high-range sub band sb.

When a high-range sub-band signal is obtained for each high-range sub band, each low-range sub-band signal and each high-range sub-band signal are then inputted and filtered (synthesized) by a band synthesis filter having 96 kHz sampling, and a high-FS object signal obtained as a result thereof is outputted. In other words, a high-FS object signal for which the sampling frequency has been upsampled to 96 kHz is obtained.

In the example illustrated in FIG. 4, in the band expansion unit 41, the band expansion processing for generating a high-FS object signal as above is independently performed for each low-FS object signal included in the input bitstream, in other words for each object.

Accordingly, in a case where the number of objects is 32, for example, in the rendering processing unit 12, rendering processing for a 96 kHz high-FS object signal must be performed for each of the 32 objects.

Similarly, in the virtualization processing unit 13 which is the subsequent stage, HRTF processing (virtualization processing) for a 96 kHz high-FS virtual speaker signal must be performed for the number of virtual speakers.

As a result, the processing load in the entire apparatus becomes enormous. This is similar even in a case where the sampling frequency for an audio signal obtained by decoding processing is 96 kHz and band expansion processing is not performed.

Accordingly, the present technique makes it such that, separately from high-range information regarding each high-range sub band directly obtained from an object signal before encoding, high-range information regarding a virtual speaker signal, etc. that is high-resolution, in other words has a high sampling frequency, is also multiplexed and transmitted with an input bitstream in advance.

In such a manner, for example, it is possible to perform decoding processing, rendering processing, and HRTF processing which have a high processing load with a low sampling frequency, and perform band expansion processing based on the transmitted high-range information on a final signal after the HRTF processing. As a result, it is possible to reduce the overall processing load, and realize high-quality audio reproduction even with a low-cost processor or battery.

### <Example of Configuration of Signal Processing Apparatus>

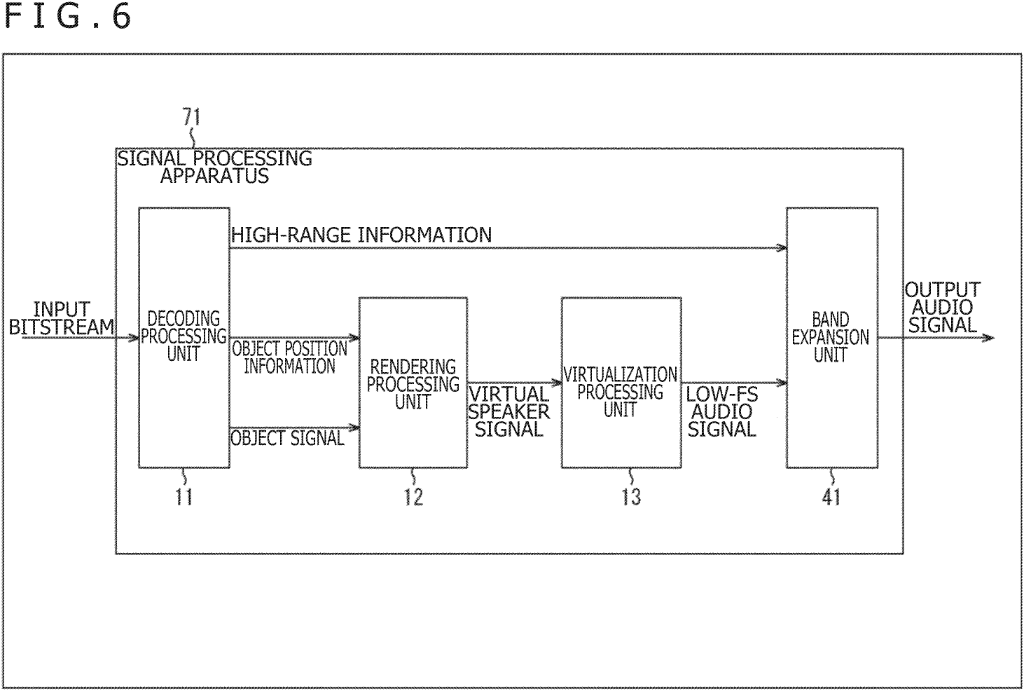

FIG. 6 is a view that illustrates an example of a configuration of an embodiment for a signal processing apparatus to which the present technique has been applied. Note that, in FIG. 6, the same reference sign is added to portions corresponding to the case in FIG. 4, and description thereof is omitted as appropriate.

A signal processing apparatus 71 illustrated in FIG. 6 is, for example, configured from a smartphone, a personal computer, etc., and has the decoding processing unit 11, the rendering processing unit 12, the virtualization processing unit 13, and the band expansion unit 41.

In the example illustrated in FIG. 4, respective processing is performed in the order of decoding processing, band expansion processing, rendering processing, and virtualization processing.

In contrast to this, in the signal processing apparatus 71, respective processing (signal processing) is performed in the order of decoding processing, rendering processing, virtualization processing, and band expansion processing. In other words, band expansion processing is performed last.

Accordingly, in the signal processing apparatus 71, firstly demultiplexing and decoding processing is performed for an input bitstream in the decoding processing unit 11. In this case, it is possible to say that the decoding processing unit 11 functions as an obtainment unit that obtains an encoded object signal for object audio, object position information, high-range information, etc. from a server, etc. (not illustrated).

The decoding processing unit 11 supplies the high-range information obtained through demultiplexing and decoding processing (decoding processing) to the band expansion unit 41, and also supplies the object position information and the object signal to the rendering processing unit 12.

Here, the input bitstream includes high-range information corresponding to an output from the virtualization processing unit 13, and the decoding processing unit 11 supplies this high-range information to the band expansion unit 41.

In addition, in the rendering processing unit 12, rendering processing such as VBAP is performed on the basis of the object position information and the object signal supplied from the decoding processing unit 11, and a virtual speaker signal obtained as a result is supplied to the virtualization processing unit 13.

In the virtualization processing unit 13, HRTF processing is performed as virtualization processing unit 13. In other words, in the virtualization processing unit 13 convolution processing based on the virtual speaker signal supplied from the rendering processing unit 12 and an HRTF coefficient corresponding to a transfer function supplied in advance as well as addition processing for adding together signals obtained as a result thereof are performed as HRTF processing. The virtualization processing unit 13 supplies the audio signal obtained by the HRTF processing to the band expansion unit 41.

In this example, for example, an object signal supplied from the decoding processing unit 11 to the rendering processing unit 12 is made to be a low-FS object signal for which the sampling frequency is 48 kHz.

In such a case, because a virtual speaker signal supplied from the rendering processing unit 12 to the virtualization processing unit 13 also has a sampling frequency of 48 kHz, the sampling frequency for an audio signal supplied from the virtualization processing unit 13 to the band expansion unit 41 is also 48 kHz.

The audio signal supplied from the virtualization processing unit 13 to the band expansion unit 41 is in particular also referred to below as a low-FS audio signal. Such a low-FS audio signal is a drive signal that is obtained by performing signal processing such as rendering processing or virtualization processing on an object signal and is for driving a reproduction apparatus such as headphones or a real speaker to cause sound to be output.

In the band expansion unit 41, an output audio signal is generated by performing, on the basis of the high-range information supplied from the decoding processing unit 11, band expansion processing on the low-FS audio signal supplied from the virtualization processing unit 13, and outputting the output audio signal to a subsequent stage. The output audio signal obtained by the band expansion unit 41 has a sampling frequency of 96 kHz, for example.

### <Syntax Example for Input Bitstream>

As described above, the band expansion unit 41 in the signal processing apparatus 71 requires high-range information corresponding to the output from the virtualization processing unit 13, and the input bitstream includes such high-range information.

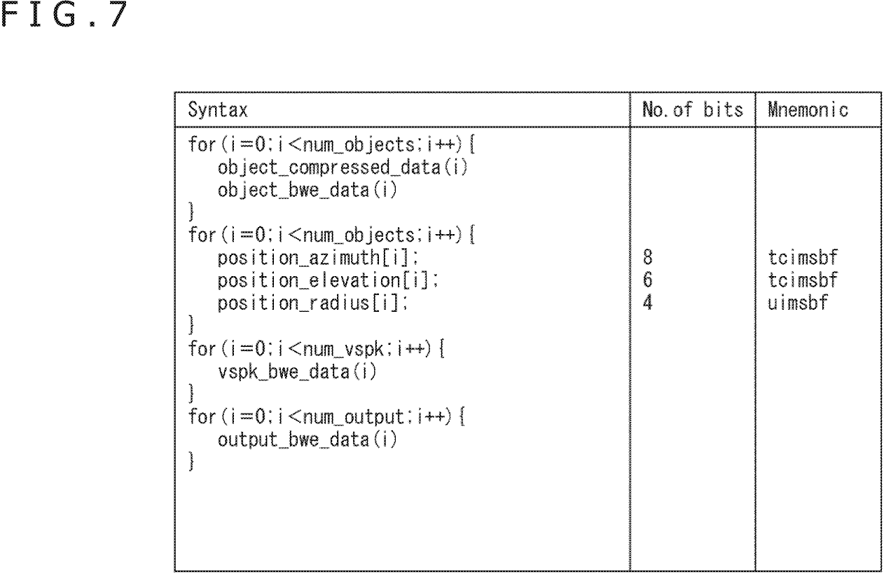

Here, a syntax example for an input bitstream supplied to the decoding processing unit 11 is illustrated in FIG. 7.

In FIG. 7, “num_objects” indicates the total number of objects, “object_compressed_data” indicates an encoded (compressed) object signal, and “object_bwe_data” indicates high-range information for band expansion for each object.

For example, as described with reference to FIG. 4, this high-range information is used in a case of performing band expansion processing on a low-FS object signal obtained through decoding processing. In other words, “object_bwe_data” is high-range information that includes average amplitude information for each high-range sub-band signal obtained from an object signal before encoding.

In addition, “position_azimuth” indicates a horizontal angle in a spherical coordinate system for an object, “position_elevation” indicates a vertical angle in the spherical coordinate system for the object, and “position_radius” indicates a distance (radius) from a spherical coordinate system origin to the object. Here, information that includes the horizontal angle, vertical angle, and distance is object position information that indicates the position of an object.

Accordingly, in this example, an encoded object signal, high-range information, and object position information for the number of objects indicated by “num_objects” are included in an input bitstream.

In addition, “num_vspk” in FIG. 7 indicates a number of virtual speakers, and “vspk_bwe_data” indicates high-range information used in a case of performing band expansion processing on a virtual speaker signal.

This high-range information is, for example, average amplitude information that is obtained by performing rendering processing on an object signal before encoding and is for each high-range sub-band signal of a virtual speaker signal having a sampling frequency higher than that of the output from the rendering processing unit 12 in the signal processing apparatus 71.

Furthermore, “num_output” indicates the number of output channels, in other words the number of channels for an output audio signal that has a multi-channel configuration and is finally outputted. “output_bwe_data” indicates high-range information for obtaining an output audio signal, in other words high-range information used in a case of performing band expansion processing on an output from the virtualization processing unit 13.

This high-range information is, for example, average amplitude information that is obtained by performing rendering processing and virtualization processing on an object signal before encoding and is for each high-range sub-band signal of an audio signal having a sampling frequency higher than that of the output from the virtualization processing unit 13 in the signal processing apparatus 71.

In such a manner, in the example illustrated in FIG. 7, a plurality of items of high-range information is included in the input bitstream, according to a timing for performing band expansion processing. Accordingly, it is possible to perform band expansion processing at a timing that corresponds to computational resources, etc. in the signal processing apparatus 71.

Specifically, for example, in a case where there is leeway in computational resources, it is possible to use the high-range information indicated by “object_bwe_data” to perform band expansion processing on a low-FS object signal that is for each object and is obtained by decoding processing as illustrated in FIG. 4.

In this case, band expansion processing is performed for each object, and subsequently rendering processing or virtualization processing is performed with a high sampling frequency.

In particular, because in this case it is possible to use band expansion processing to obtain an object signal before encoding, in other words a signal close to the original sound, it is possible to obtain an output audio signal having higher-quality than in a case of performing band expansion processing after rendering processing or after virtualization processing.

In contrast, for example, in a case where there is no leeway for computational resources, it is possible to, as in the signal processing apparatus 71, perform decoding processing, rendering processing, and virtualization processing with a low sampling frequency, and subsequently use the high-range information indicated by “output_bwe_data” to perform band expansion processing with respect to a low-FS audio signal. In such a manner, it is possible to significantly reduce the overall amount of processing (processing load).

In addition, for example, in a case where a reproduction apparatus is a speaker, it may be that decoding processing and rendering processing are performed with a low sampling frequency, and subsequently high-range information indicated by “vspk_bwe_data” is used to perform band expansion processing on a virtual speaker signal.

When a plurality of items of high-range information such as “object_bwe_data,” “output_bwe_data,” or “vspk_bwe_data” is made to be included in one input bitstream as above, the compression efficiency decreases. However, the amount of data for these items of high-range information is very small in comparison to the amount of data for an encoded object signal “object_compressed_data,” and thus it is possible to achieve a larger processing load reduction effect in comparison to the amount of increase for the amount of data.

### <Description of Signal Generation Processing>

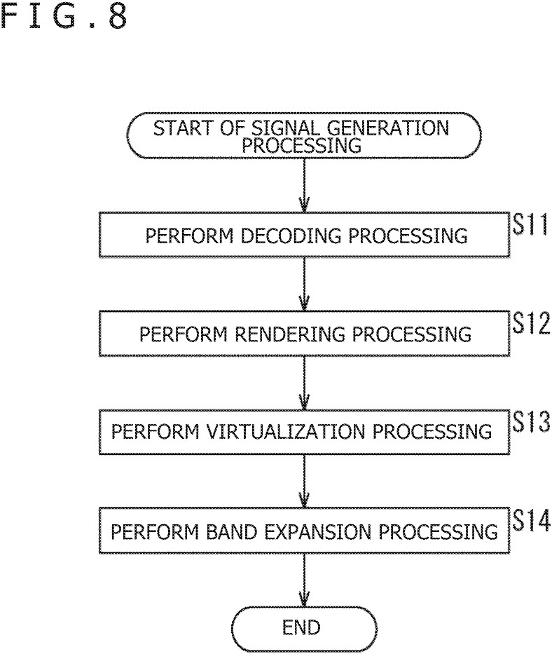

Next, description is given regarding operation by the signal processing apparatus 71 illustrated in FIG. 6. In other words, with reference to the flow chart in FIG. 8, description is given below regarding signal generation processing performed by the signal processing apparatus 71.

In step S11, the decoding processing unit 11 performs demultiplexing and decoding processing on a supplied input bitstream, and supplies high-range information obtained as a result thereof to the band expansion unit 41 and also supplies object position information and an object signal to the rendering processing unit 12.

Here, for example, high-range information indicated by “output_bwe_data” indicated in FIG. 7 is extracted from the input bitstream and supplied to the band expansion unit 41.

In step S12, the rendering processing unit 12 performs rendering processing on the basis of the object position information and the object signal supplied from the decoding processing unit 11, and supplies a virtual speaker signal obtained as a result thereof to the virtualization processing unit 13. For example, in step S12, VBAP, etc. is performed as the rendering processing.

In step S13, the virtualization processing unit 13 performs virtualization processing. For example, in step S13, HRTF processing is performed as the virtualization processing.

In this case, the virtualization processing unit 13 convolves the virtual speaker signals for respective virtual speakers supplied from the rendering processing unit 12 with HRTF coefficients for respective virtual speakers that are held in advance, and a process that adds signals obtained as a result thereof is performed as HRTF processing. The virtualization processing unit 13 supplies a low-FS audio signal obtained by the HRTF processing to the band expansion unit 41.

In step S14, the band expansion unit 41, on the basis of the high-range information supplied from the decoding processing unit 11, performs band expansion processing on the low-FS audio signal supplied from the virtualization processing unit 13, and outputs an output audio signal obtained as a result thereof to a subsequent stage. When an output audio signal is generated in such a manner, the signal generation processing ends.

In the above manner, the signal processing apparatus 71 uses high-range information extracted (read out) from an input bitstream to perform band expansion processing and generate an output audio signal.

In this case, by performing band expansion processing on a low-FS audio signal obtained by rendering processing and HRTF processing being performed, it is possible to reduce the processing load, in other words the amount of calculations, in the signal processing apparatus 71. Accordingly, it is possible to perform high-quality audio reproduction even if the signal processing apparatus 71 is a low-cost apparatus.

### <Example of Configuration of Signal Processing Apparatus>

Note that, when an output destination, in other words a reproduction apparatus, for an output audio signal obtained by the band expansion unit 41 is a speaker instead of headphones, it is possible to perform band expansion processing on a virtual speaker signal obtained by the rendering processing unit 12.

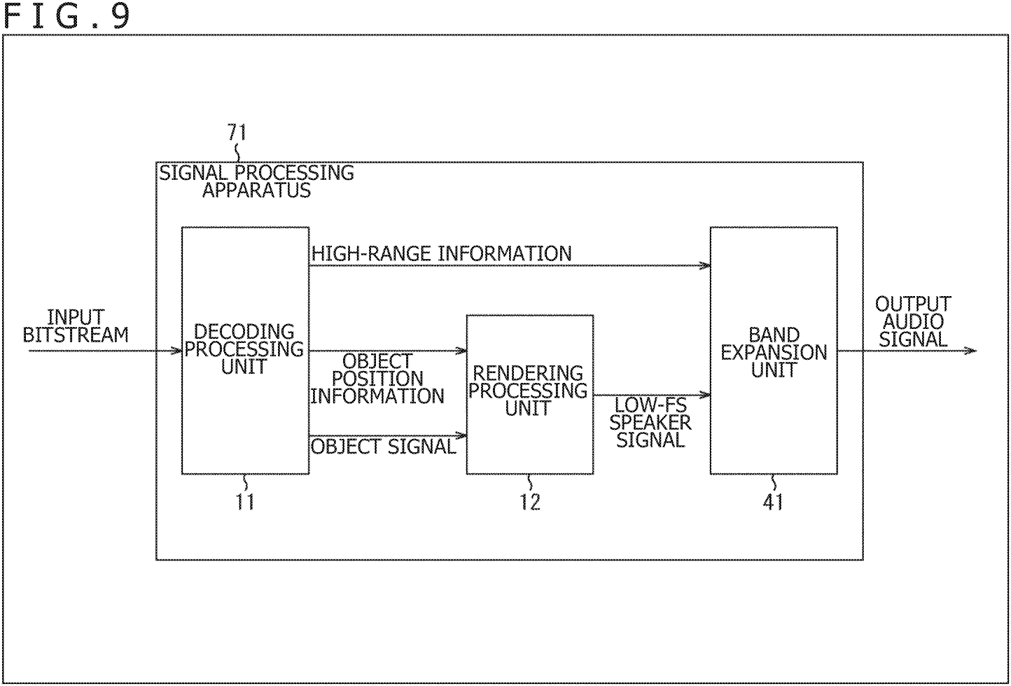

In such a case, the configuration of the signal processing apparatus 71 becomes as illustrated in FIG. 9. Note that, in FIG. 9, the same reference sign is added to portions corresponding to the case in FIG. 6, and description thereof is omitted as appropriate.

The signal processing apparatus 71 illustrated in FIG. 9 has the decoding processing unit 11, the rendering processing unit 12, and the band expansion unit 41.

The configuration of the signal processing apparatus 71 illustrated in FIG. 9 differs from the configuration of the signal processing apparatus 71 in FIG. 6 in that the virtualization processing unit 13 is not provided, and is the same configuration as that of the signal processing apparatus 71 in FIG. 6 in other points.

Accordingly, in the signal processing apparatus 71 illustrated in FIG. 9, after processing for step S11 and step S12 described with reference to FIG. 8 is performed, the processing for step S14 is performed with processing for step S13 being performed, whereby an output audio signal is generated.

Accordingly, in step S11, the decoding processing unit 11 extracts the high-range information indicated by “vspk_bwe_data” indicated in FIG. 7, for example, from the input bitstream, and supplies the high-range information to the band expansion unit 41. In addition, when the rendering processing in step S12 is performed, the rendering processing unit 12 supplies an obtained speaker signal to the band expansion unit 41. This speaker signal corresponds to a virtual speaker signal obtained by the rendering processing unit 12 in FIG. 6, and, for example, is a low-FS speaker signal having a sampling frequency of 48 kHz.

Furthermore, the band expansion unit 41, on the basis of the high-range information supplied from the decoding processing unit 11, performs band expansion processing on the speaker signal supplied from the rendering processing unit 12, and outputs an output audio signal obtained as a result thereof to a subsequent stage.

In such a manner, it is possible to reduce the processing load (amount of calculations) for the entirety of the signal processing apparatus 71, even in a case where rendering processing is performed before band expansion processing.

### <Example of Configuration of Encoder>

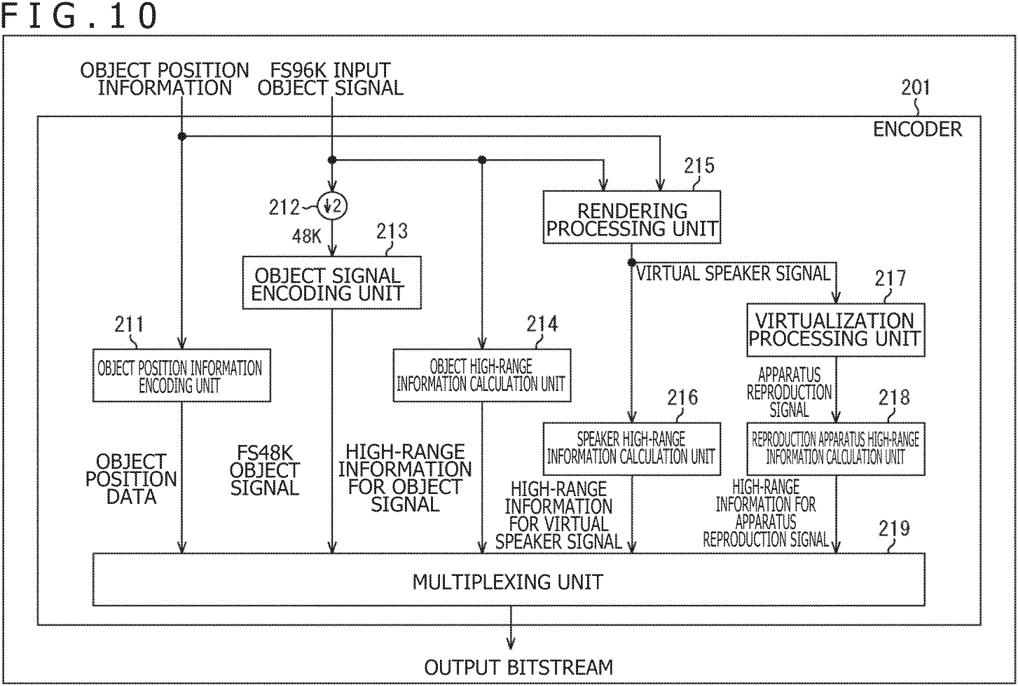

Next, description is given regarding an encoder (encoding apparatus) that generates the input bitstream illustrated in FIG. 7. Such an encoder is configured as illustrated in FIG. 10, for example.

An encoder 201 illustrated in FIG. 10 has an object position information encoding unit 211, a downsampler 212, an object signal encoding unit 213, an object high-range information calculation unit 214, a rendering processing unit 215, a speaker high-range information calculation unit 216, a virtualization processing unit 217, a reproduction apparatus high-range information calculation unit 218, and a multiplexing unit 219.

The encoder 201 is inputted (supplied) with an object signal for an object that is an encoding target, and object position information indicating the position of the object. Here, the object signal that the encoder 201 is inputted with is, for example, assumed to be a signal for which the sampling frequency is 96 kHz.

The object position information encoding unit 211 encodes inputted object position information, and supplies the encoded object position information to the multiplexing unit 219.

As a result, for example, encoded object position information (object position data) that includes the horizontal angle “position_azimuth,” the vertical angle “position_elevation,” and the radius “position_radius” which are illustrated in FIG. 7 is obtained as the encoded object position information.

The downsampler 212 performs downsampling processing, in other words a band limitation, on an inputted object signal having a sampling frequency of 96 kHz, and supplies an object signal, which has a sampling frequency of 48 kHz and is obtained as a result thereof, to the object signal encoding unit 213.

The object signal encoding unit 213 encodes the 48 kHz object signal supplied from the downsampler 212, and supplies the encoded 48 kHz object signal to the multiplexing unit 219. As a result, for example, the “object_compressed_data” indicated in FIG. 7 is obtained as an encoded object signal.

Note that an encoding method in the object signal encoding unit 213 may be an encoding method in an MPEG-H Part 3:3D audio standard or may be another encoding method. In other words, it is sufficient if the encoding method in the object signal encoding unit 213 corresponds to (is the same standard as) the decoding method in the decoding processing unit 11.

The object high-range information calculation unit 214 calculates high-range information (band expansion information) on the basis of an inputted 96 kHz object signal and also compresses and encodes obtained high-range information and supplies the compressed and encoded high-range information to the multiplexing unit 219. As a result, for example, the “object_bwe_data” indicated in FIG. 7 is obtained as encoded high-range information.

The high-range information generated by the object high-range information calculation unit 214 is average amplitude information (an average amplitude value) for each high-range sub band illustrated in FIG. 5, for example.

For example, the object high-range information calculation unit 214 performs filtering based on a bandpass filter bank on an inputted 96 kHz object signal, and obtains a high-range sub-band signal for each high-range sub band. The object high-range information calculation unit 214 then generates high-range information by calculating an average amplitude value for a time frame for each of these high-range sub-band signals.

The rendering processing unit 215 performs rendering processing such as VBAP on the basis of object position information and a 96 kHz object signal that are inputted, and supplies a virtual speaker signal obtained as a result thereof to the speaker high-range information calculation unit 216 and the virtualization processing unit 217.

Note that the rendering processing in the rendering processing unit 215 is not limited to VBAP and may be other rendering processing if the rendering processing in the rendering processing unit 215 is the same processing as a case for the rendering processing unit 12 in the signal processing apparatus 71 which is a decoding side (reproduction side).

The speaker high-range information calculation unit 216 calculates high-range information on the basis of each channel supplied from the rendering processing unit 215, in other words the virtual speaker signal for each virtual speaker, and also compresses and encodes the obtained high-range information and supplies the compressed and encoded high-range information to the multiplexing unit 219.

For example, in the speaker high-range information calculation unit 216, high-range information is generated from a virtual speaker signal by a similar method to a case for the object high-range information calculation unit 214. As a result, for example, the “vspk_bwe_data” indicated in FIG. 7, is obtained as encoded high-range information for a virtual speaker signal.

High-range information obtained in such a manner is, for example, used in band expansion processing in the signal processing apparatus 71 in a case where a number of speakers and speaker dispositions on a reproduction side, in other words the signal processing apparatus 71 side, are the same as the number of speakers and speaker dispositions for the virtual speaker signals obtained by the rendering processing unit 215. For example, in a case where the signal processing apparatus 71 has the configuration illustrated in FIG. 9, the high-range information generated in the speaker high-range information calculation unit 216 is used in the band expansion unit 41.

The virtualization processing unit 217 performs virtualization processing such as HRTF processing on a virtual speaker signal supplied from the rendering processing unit 215, and supplies an apparatus reproduction signal obtained as a result thereof to the reproduction apparatus high-range information calculation unit 218.

Note that the apparatus reproduction signal referred to here is an audio signal for reproducing object audio by mainly headphones or a plurality of speakers, and in other words is a drive signal for a reproduction apparatus.

For example, in a case where headphone reproduction is envisioned, the apparatus reproduction signal is a stereo signal (stereo signal drive signal) for headphones.

In addition, for example, in a case where speaker reproduction is envisioned, the apparatus reproduction signal is a speaker reproduction signal (drive signal for a speaker) that is supplied to a speaker.

In this case, the apparatus reproduction signal differs from a virtual speaker signal obtained by the rendering processing unit 215, and an apparatus reproduction signal resulting from trans-aural processing according to the number and disposition of real speakers in addition to HRTF processing being performed is often generated. In other words, HRTF processing and trans-aural processing are performed as virtualization processing.

Generating high-range information at a latter stage from an apparatus reproduction signal obtained in such a manner is, for example, particularly useful in a case where the number of speakers and speaker dispositions on a reproduction side differs to the number of speakers and speaker dispositions for virtual speaker signals obtained in the rendering processing unit 215.

The reproduction apparatus high-range information calculation unit 218 calculates high-range information on the basis of the apparatus reproduction signal supplied from the virtualization processing unit 217, and also compresses and encodes the obtained high-range information and supplies the compressed and encoded high-range information to the multiplexing unit 219.

For example, in the reproduction apparatus high-range information calculation unit 218, high-range information is generated from an apparatus reproduction signal by a similar method to a case for the object high-range information calculation unit 214. As a result, for example, the “output_bwe_data” indicated in FIG. 7 is obtained as encoded high-range information for an apparatus reproduction signal, in other words for a low-FS audio signal.

Note that, in the reproduction apparatus high-range information calculation unit 218, in addition to any one of high-range information for which headphone reproduction is envisioned and high-range information for which speaker reproduction is envisioned, both of these may be generated and supplied to the multiplexing unit 219. In addition, even in a case where speaker reproduction is envisioned, high-range information may be generated for each channel configuration, such as two channels or 5.1 channels, for example.

The multiplexing unit 219 multiplexes encoded object position information supplied from the object position information encoding unit 211, an encoded object signal supplied from the object signal encoding unit 213, encoded high-range information supplied from the object high-range information calculation unit 214, encoded high-range information supplied from the speaker high-range information calculation unit 216, and encoded high-range information supplied from the reproduction apparatus high-range information calculation unit 218.

The multiplexing unit 219 outputs an output bitstream obtained by the multiplexing the object position information, object signal, and high-range information. This output bitstream is inputted to the signal processing apparatus 71 as an input bitstream.

### <Description of Encoding Processing>

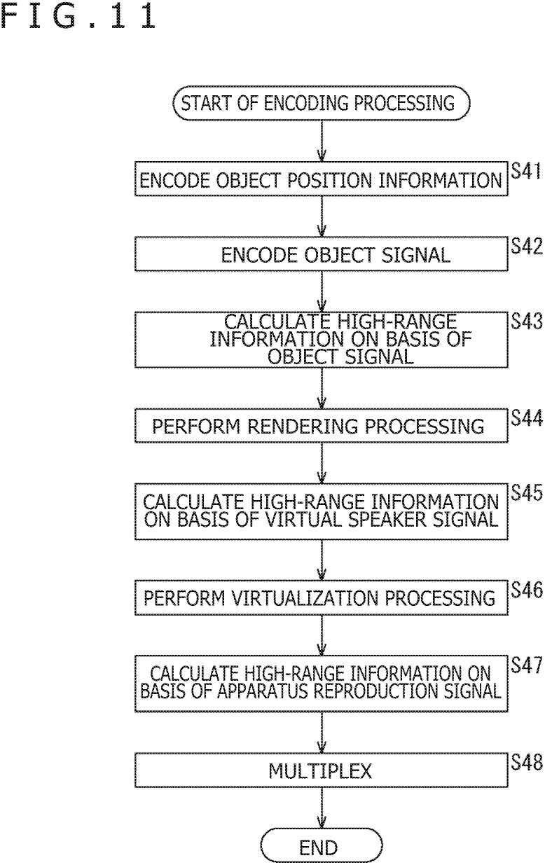

Next, description is given regarding operation by the encoder 201. In other words, with reference to the flow chart in FIG. 11, description is given below regarding encoding processing by the encoder 201.

In step S41, the object position information encoding unit 211 encodes inputted object position information and supplies the encoded object position information to the multiplexing unit 219.

In addition, the downsampler 212 downsamples an inputted object signal and supplies the downsampled object signal to the object signal encoding unit 213.

In step S42, the object signal encoding unit 213 encodes the object signal supplied from the downsampler 212 and supplies the encoded object signal to the multiplexing unit 219.

In step S43, the object high-range information calculation unit 214 calculates high-range information on the basis of the inputted object signal, and also compresses and encodes obtained high-range information and supplies the compressed and encoded high-range information to the multiplexing unit 219.

In step S44, the rendering processing unit 215 performs rendering processing on the basis of object position information and an object signal that are inputted, and supplies a virtual speaker signal obtained as a result thereof to the speaker high-range information calculation unit 216 and the virtualization processing unit 217.

In step S45, the speaker high-range information calculation unit 216 calculates high-range information on the basis of the virtual speaker signal supplied from the rendering processing unit 215, and also compresses and encodes the obtained high-range information and supplies the compressed and encoded high-range information to the multiplexing unit 219.

In step S46, the virtualization processing unit 217 performs virtualization processing such as HRTF processing on a virtual speaker signal supplied from the rendering processing unit 215, and supplies an apparatus reproduction signal obtained as a result thereof to the reproduction apparatus high-range information calculation unit 218.

In step S47, the reproduction apparatus high-range information calculation unit 218 calculates high-range information on the basis of the apparatus reproduction signal supplied from the virtualization processing unit 217, and also compresses and encodes the obtained high-range information and supplies the compressed and encoded high-range information to the multiplexing unit 219.

In step S48, the multiplexing unit 219 multiplexes encoded object position information supplied from the object position information encoding unit 211, an encoded object signal supplied from the object signal encoding unit 213, encoded high-range information supplied from the object high-range information calculation unit 214, encoded high-range information supplied from the speaker high-range information calculation unit 216, and encoded high-range information supplied from the reproduction apparatus high-range information calculation unit 218.

The multiplexing unit 219 outputs an output bitstream obtained by the multiplexing, and the encoding processing ends.

In the above manner, the encoder 201 calculates high-range information for a virtual speaker signal or an apparatus reproduction signal in addition to high-range information for an object signal, and stores these in an output bitstream. In such a manner, it is possible to perform band expansion processing at a desired timing on a decoding side for the output bitstream, and it is possible to reduce the amount of calculations. As a result, it is possible to perform band expansion processing and high-quality audio reproduction, even with a low-cost apparatus.

### First Variation of First Embodiment

### <Example of Configuration of Signal Processing Apparatus>

Note that there are also cases where it is possible to perform rendering processing or virtualization processing after band expansion processing is performed with respect to an object signal, according to the presence or absence of leeway in the processing ability or computational resources (computational resources) of the signal processing apparatus 71, a remaining amount of battery (remaining amount of power), an amount of power consumption in each instance of processing, a reproduction time period for content, etc.

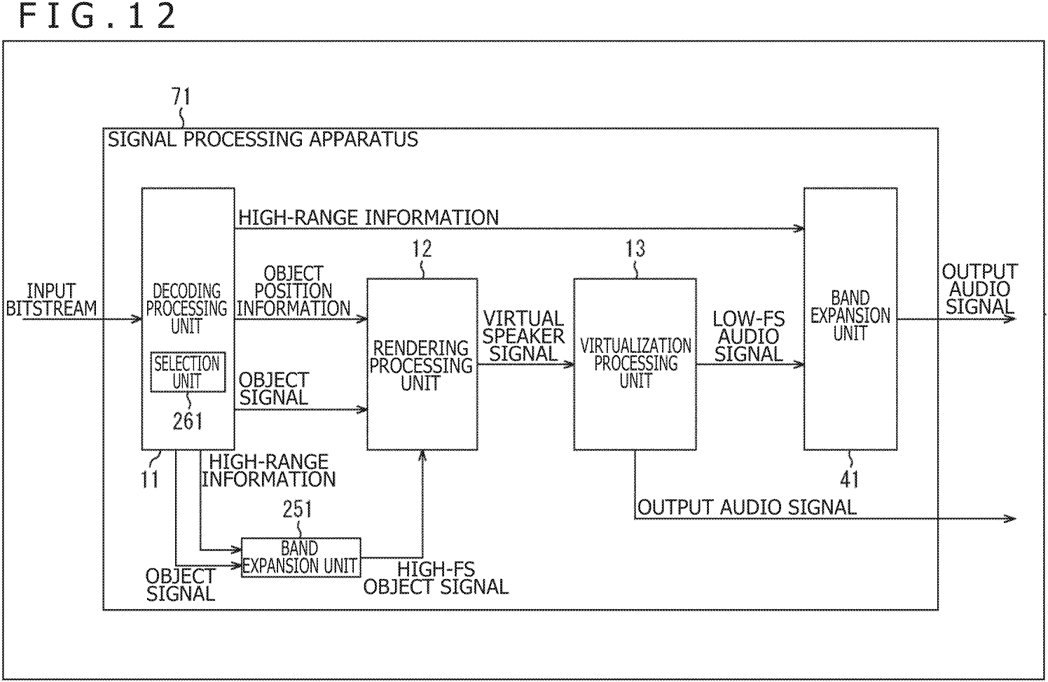

Accordingly, in may be that at what timing to perform band expansion processing is selected on the signal processing apparatus 71 side. In such a case, the configuration of the signal processing apparatus 71 becomes as illustrated in FIG. 12, for example. Note that, in FIG. 12, the same reference sign is added to portions corresponding to the case in FIG. 6, and description thereof is omitted as appropriate.

The signal processing apparatus 71 illustrated in FIG. 12 has the decoding processing unit 11, a band expansion unit 251, the rendering processing unit 12, the virtualization processing unit 13, and the band expansion unit 41. In addition, a selection unit 261 is also provided in the decoding processing unit 11.

The configuration of the signal processing apparatus 71 illustrated in FIG. 12 differs from the signal processing apparatus 71 in FIG. 6 in that the band expansion unit 251 and the selection unit 261 are newly provided, and is the same configuration as that of the signal processing apparatus 71 in FIG. 6 in other points.

The selection unit 261 performs selection processing for selecting which of high-range information for an object signal and high-range information for a low-FS audio signal to perform band expansion processing on the basis thereof. In other words, a selection is made whether to use high-range information for an object signal to perform band expansion processing on the object signal, or use high-range information for a low-FS audio signal to perform band expansion processing on the low-FS audio signal.

This selection processing is performed on the basis of, for example, computational resources at the current time in the signal processing apparatus 71, an amount of power consumption in each instance of processing from decoding processing to band expansion processing in the signal processing apparatus 71, a remaining amount of battery at the current time in the signal processing apparatus 71, a reproduction time period for content based on an output audio signal, etc.

Specifically, for example, because a total amount of power consumption required until the end of content reproduction is known from the reproduction time period for the content and amount of power consumption for each instance of processing, band expansion processing using high-range information for an object signal is selected when the remaining amount of battery is greater than or equal to the total amount of power consumption.

In this case, even partway through content reproduction, band expansion processing using high-range information for a low-FS audio signal is switched to, when the remaining amount of battery has gotten low due to some kind of reason or when there ceases to be leeway for computational resources, for example. Note that it is sufficient if, at a time of such switching of band expansion processing, crossfade processing is performed with respect to an output audio signal, as appropriate.

In addition, for example, in a case where there is no leeway in the computational resources or remaining amount of battery from before content reproduction, band expansion processing using high-range information for a low-FS audio signal is selected at a time of the start of content reproduction.

The decoding processing unit 11 outputs high-range information or an object signal obtained through decoding processing, in response to a selection result from the selection unit 261.

In other words, in a case where band expansion processing using high-range information for a low-FS audio signal is selected, the decoding processing unit 11 supplies high-range information, which is for a low-FS audio signal and is obtained through the decoding processing, to the band expansion unit 41, and also supplies object position information and an object signal to the rendering processing unit 12.

In contrast to this, in a case where band expansion processing using high-range information for an object signal is selected, the decoding processing unit 11 supplies high-range information, which is for an object signal and is obtained through the decoding processing, to the band expansion unit 251, and also supplies object position information and an object signal to the rendering processing unit 12.

The band expansion unit 251 performs band expansion processing on the basis of the high-range information for the object signal and the object signal which are supplied from the decoding processing unit 11, and supplies an object signal, which has a higher sampling frequency and is obtained as a result thereof, to the rendering processing unit 12.

### <Description of Signal Generation Processing>

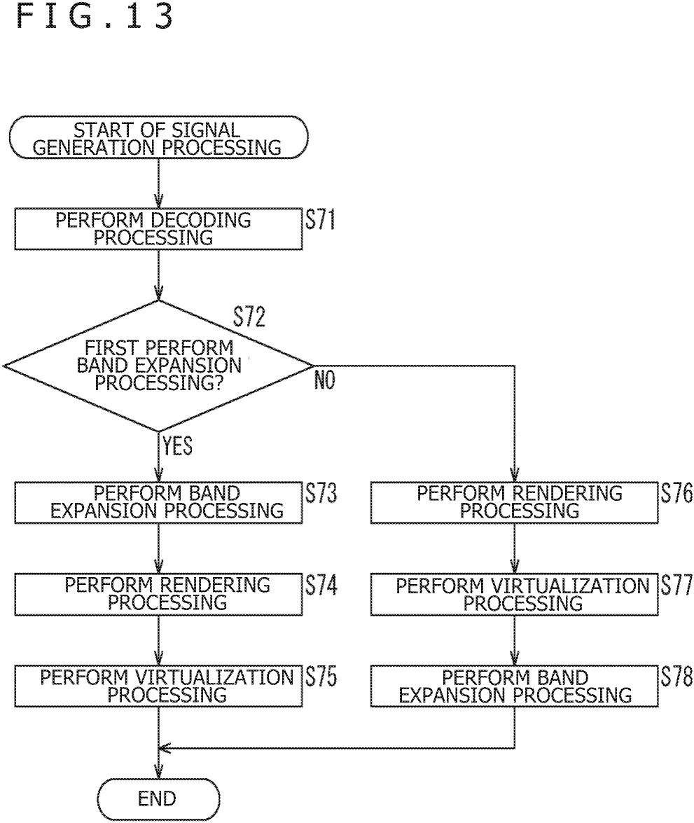

Next, description is given regarding operation by the signal processing apparatus 71 illustrated in FIG. 12. In other words, with reference to the flow chart in FIG. 13, description is given below regarding signal generation processing performed by the signal processing apparatus 71 in FIG. 12.

In step S71, the decoding processing unit 11 performs demultiplexing and decoding processing on a supplied input bitstream.

In step S72, the selection unit 261 determines, on the basis of at least any one of computational resources for the signal processing apparatus 71, an amount of power consumption for each instance of processing, a remaining amount of battery, and a reproduction time period for content, whether to perform band expansion processing before rendering processing and virtualization processing. In other words, a selection is made as to which high-range information, from among high-range information for an object signal and high-range information for a low-FS audio signal, to use to perform band expansion processing.

In a case where performing band expansion processing earlier is determined in step S72, in other words in a case where band expansion processing using high-range information for an object signal is selected, the processing subsequently proceeds to step S73.

In such a case, the decoding processing unit 11 supplies the high-range information for the object signal and the object signal which are obtained by the decoding processing to the band expansion unit 251, and also supplies the object position information to the rendering processing unit 12.

In step S73, the band expansion unit 251 performs band expansion processing on the basis of the high-range information and the object signal which are supplied from the decoding processing unit 11, and supplies an object signal having a higher sampling frequency obtained as a result thereof, in other words a high-FS object signal, to the rendering processing unit 12.

In step S73, processing similar to step S14 in FIG. 8 is performed. However, in this case, for example, band expansion processing is performed in which the high-range information “object_bwe_data” indicated in FIG. 7 is used as the high-range information for an object signal.

In step S74, the rendering processing unit 12 performs rendering processing such as VBAP on the basis of the object position information supplied from the decoding processing unit 11 and the high-FS object signal supplied from the band expansion unit 251, and supplies a high-FS virtual speaker signal obtained as a result to the virtualization processing unit 13.

In step S75, the virtualization processing unit 13 performs virtualization processing on the basis of the high-FS virtual speaker signal supplied from the rendering processing unit 12 and an HRTF coefficient which is held in advance. In step S75, processing similar to step S13 in FIG. 8 is performed.

The virtualization processing unit 13 outputs, as an output audio signal, an audio signal obtained by the virtualization processing to a subsequent stage, and the signal generation processing ends.

In contrast to this, in a case where not performing band expansion processing first is determined in step S72, in other words in a case where band expansion processing using high-range information for a low-FS audio signal is selected, the processing subsequently proceeds to step S76.

In such a case, the decoding processing unit 11 supplies the high-range information for the low-FS audio signal and the object signal which are obtained by the decoding processing to the band expansion unit 41, and also supplies the object position information to the rendering processing unit 12.

Subsequently, processing in step S76 through step S78 is performed and the signal generation processing ends, but because this processing is similar to the processing in step S12 through step S14 in FIG. 8, description thereof is omitted. In such a case, in step S78, for example, band expansion processing is performed in which the high-range information “output_bwe_data” indicated in FIG. 7 is used.

In the signal processing apparatus 71, the signal generation processing described above is performed at a predetermined time interval, such as for each frame for content, in other words an object signal.

In the above manner, the signal processing apparatus 71 selects which high-range information to use to perform band expansion processing, performs each instance of processing in a processing order that corresponds to a selection result, and generates an output audio signal. As a result, it is possible to perform band expansion processing and generate an output audio signal according to computational resources or a remaining amount of battery. Accordingly, it is possible to reduce an amount of calculations if necessary, and perform high-quality audio reproduction even with a low-cost apparatus.

Note that, in the signal processing apparatus 71 illustrated in FIG. 12, a band expansion unit that performs band expansion processing on a virtual speaker signal may be further provided.

In such a case, this band expansion unit performs, on the basis of the high-range information that is for a virtual speaker signal and is supplied from the decoding processing unit 11, band expansion processing on the virtual speaker signal supplied from the rendering processing unit 12, and supplies a virtual speaker signal that has a higher sampling frequency and is obtained as a result thereof to the virtualization processing unit 13.

Accordingly, the selection unit 261 can select whether to perform band expansion processing on an object signal, perform band expansion processing on a virtual speaker signal, or perform band expansion processing on a low-FS audio signal.

### Second Embodiment

### <Example of Configuration of Signal Processing Apparatus>

Incidentally, description is given above regarding an example in which an object signal obtained by decoding processing in the signal processing apparatus 71 is a low-FS object signal having a sampling frequency of 48 kHz. In this example, rendering processing and virtualization processing are performed on a low-FS object signal obtained by decoding processing, band expansion processing is subsequently performed, and an output audio signal having a sampling frequency of 96 kHz is generated.

However, there is no limitation to this, and, for example, the sampling frequency of an object signal obtained by decoding processing may be 96 kHz which is the same as that of the output audio signal, or a higher sampling frequency than that for the output audio signal.

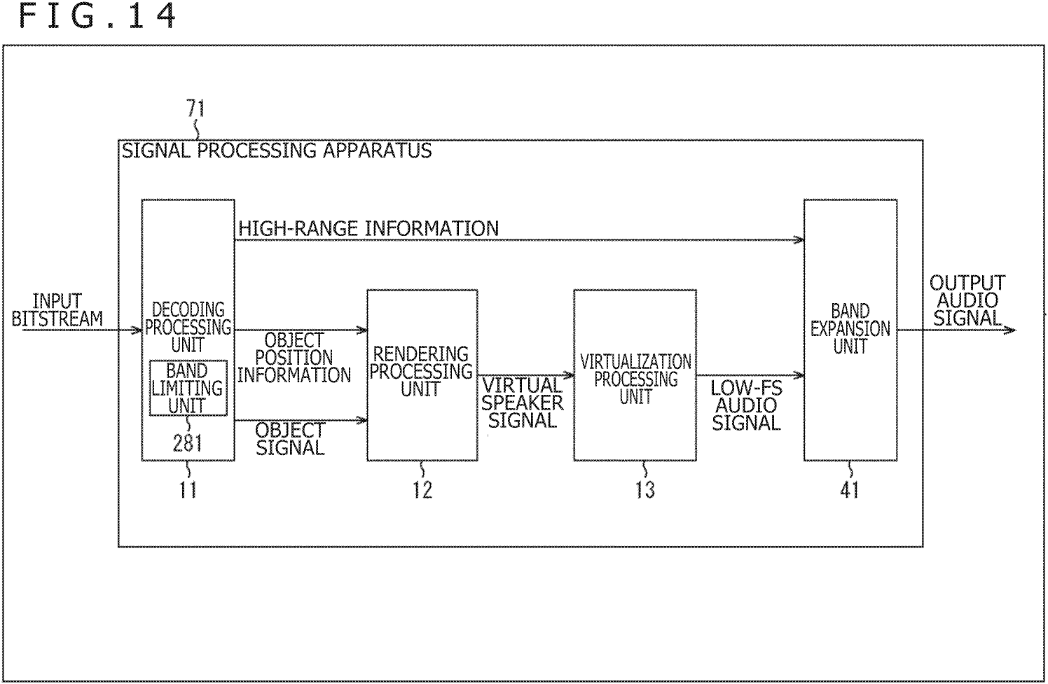

In such a case, the configuration of the signal processing apparatus 71 becomes as illustrated in FIG. 14, for example. Note that, in FIG. 14, the same reference sign is added to portions corresponding to the case in FIG. 6, and description thereof is omitted.

The signal processing apparatus 71 illustrated in FIG. 14 has the decoding processing unit 11, the rendering processing unit 12, the virtualization processing unit 13, and the band expansion unit 41. In addition, a band limiting unit 281 that performs band limiting, in other words downsampling, on the object signal is provided in the decoding processing unit 11.

The configuration of the signal processing apparatus 71 illustrated in FIG. 14 differs from the signal processing apparatus 71 in FIG. 6 in that the band limiting unit 281 is newly provided, and is the same configuration as that of the signal processing apparatus 71 in FIG. 6 in other points.

In the example in FIG. 14, when demultiplexing and decoding processing for an input bitstream is performed in the decoding processing unit 11, for example, an object signal having a sampling frequency of 96 kHz is obtained.

Accordingly, the band limiting unit 281 in the decoding processing unit 11 performs band limiting on an object signal that is obtained through the decoding processing and has a sampling frequency of 96 kHz to thereby generate a low-FS object signal having a sampling frequency of 48 kHz. For example, downsampling is performed as processing for band limiting here.

The decoding processing unit 11 supplies the low-FS object signal obtained by the band limiting and object position information obtained by decoding processing to the rendering processing unit 12.

In addition, for example, in a case of a method in which a MDCT (Modified Discrete Cosine Transform) (modified discrete cosine transform) is used to perform a time-frequency conversion as with an encoding method in an MPEG-H Part 3:3D audio standard, it is possible to obtain a low-FS object signal without performing downsampling.

In such a case, the band limiting unit 281 partially performs an inverse transformation (IMDCT (Inverse Discrete Cosine Transform)) on an MDCT coefficient (spectral data) which corresponds to an object signal to thereby generate a low-FS object signal having sampling frequency of 48 kHz, and supplies the low-FS object signal to the rendering processing unit 12. Note that, for example, Japanese Patent Laid-Open No. 2001-285073, etc. describes in detail a technique for using IMDCT to obtain a signal having a lower sampling frequency.

In the above manner, when a low-FS object signal and object position information are supplied from the decoding processing unit 11 to the rendering processing unit 12, thereafter processing similar to step S12 through step S14 in FIG. 8 is performed, and an output audio signal is generated. In this case, rendering processing and virtualization processing are performed on a signal having a sampling frequency of 48 kHz.

In this embodiment, because the object signal obtained by decoding processing is a 96 kHz signal, band expansion processing using high-range information in the band expansion unit 41 is performed only for reducing the amount of calculations in the signal processing apparatus 71.

As above, even in a case where the object signal obtained by the decoding processing is a 96 kHz signal, it is possible to significantly reduce the amount of calculations by temporarily generating a low-FS object signal and performing rendering processing or virtualization processing with a sampling frequency of 48 kHz.

Note that, in a case where there is a significant leeway for computational resources in the signal processing apparatus 71, it may be that all processing, in other words rendering processing or virtualization processing, is performed with a sampling frequency of 96 kHz, and this is also desirable from a perspective of fidelity to the original sound.

Further, the selection unit 261 may be provided in the decoding processing unit 11 as in the example illustrated in FIG. 12.

In such a case, while monitoring the computational resources or the remaining amount of battery for the signal processing apparatus 71, the selection unit 261 selects whether to perform rendering processing or virtualization processing with the sampling frequency unchanged at 96 kHz and then perform band expansion processing, or generate a low-FS object signal and perform rendering processing or virtualization processing with the sampling frequency at 48 kHz.

In addition, it may be that crossfade processing, etc. is performed on an output audio signal by the band expansion unit 41, for example, whereby switching is dynamically performed between performing rendering processing or virtualization processing with the sampling frequency unchanged at 96 kHz or performing rendering processing or virtualization processing with the sampling frequency at 48 kHz.

Furthermore, for example, in a case where band limiting is performed by the band limiting unit 281, it may be that the decoding processing unit 11, on the basis of a 96 kHz object signal obtained by decoding processing, generates high-range information for a low-FS audio signal and supplies this high-range information for a low-FS audio signal to the band expansion unit 41.

In addition, similarly to the case in FIG. 14, it may be that the band limiting unit 281 is also provided in the decoding processing unit 11 in the signal processing apparatus 71 illustrated in FIG. 9, for example.

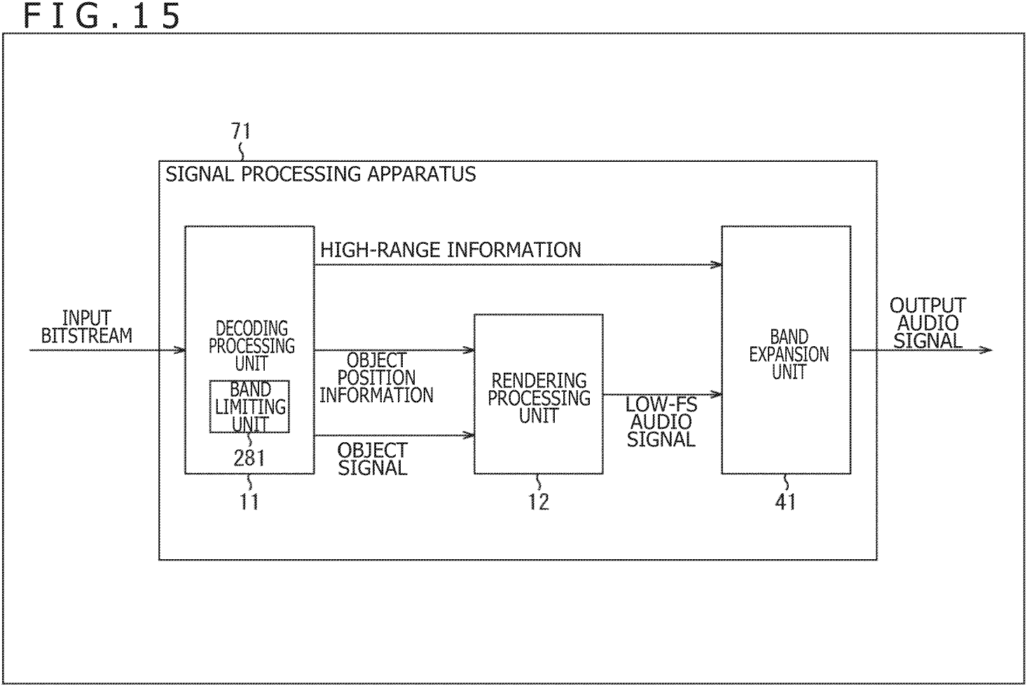

In such a case, the configuration of the signal processing apparatus 71 becomes as illustrated in FIG. 15, for example. Note that, in FIG. 15, the same reference sign is added to portions corresponding to the case in FIG. 9 or FIG. 14, and description thereof is omitted as appropriate.

In the example illustrated in FIG. 15, the signal processing apparatus 71 has the decoding processing unit 11, the rendering processing unit 12, and the band expansion unit 41, and the band limiting unit 281 is provided in the decoding processing unit 11.

In this case, the band limiting unit 281 performs band limiting on a 96 kHz object signal obtained by decoding processing, and generates a 48 kHz low-FS object signal. A low-FS object signal obtained in such a manner is supplied to the rendering processing unit 12 together with object position information.

In addition, in this example, it may be that the decoding processing unit 11, on the basis of a 96 kHz object signal obtained by decoding processing, generates high-range information for a low-FS speaker signal and supplies this high-range information for a low-FS speaker signal to the band expansion unit 41.

In addition, it may be that the band limiting unit 281 is also provided in the decoding processing unit 11 in the signal processing apparatus 71 illustrated in FIG. 12. In such a case, for example, a low-FS object signal obtained by band limiting in the band limiting unit 281 is supplied to the rendering processing unit 12, and subsequently rendering processing, virtualization processing, and band expansion processing are performed. Accordingly, in such a case, for example, a selection is made in the selection unit 261 whether to perform rendering processing and virtualization processing after band expansion is performed in the band expansion unit 251, whether to perform rendering processing, virtualization processing and band expansion processing after performing band limiting, or whether to perform rendering processing, virtualization processing, and band expansion processing without performing band limiting.

By virtue of the present technique as above, high-range information with respect to a signal after signal processing such as rendering processing or virtualization processing is used to perform band expansion processing instead of high-range information regarding an object signal on a decoding side (reproduction side), whereby it is possible to perform decoding processing, rendering processing, or virtualization processing with a low sampling frequency, and significantly reduce an amount of calculations. As a result, for example, it is possible to employ a low-cost processor or reduce an amount of power usage for a processor, and it becomes possible to perform continuous reproduction of a high-resolution sound source for a longer amount of time on a portable device such as a smartphone.

### <Example of Configuration of Computer>

Incidentally, a series of processing described above can be executed by hardware and can also be executed by software. In a case of executing a series of processing by software, a program that constitutes the software is installed onto a computer. Here, the computer includes a computer that is incorporated into dedicated hardware or, for example, a general-purpose personal computer, etc., that can execute various functions by various programs being installed therein.

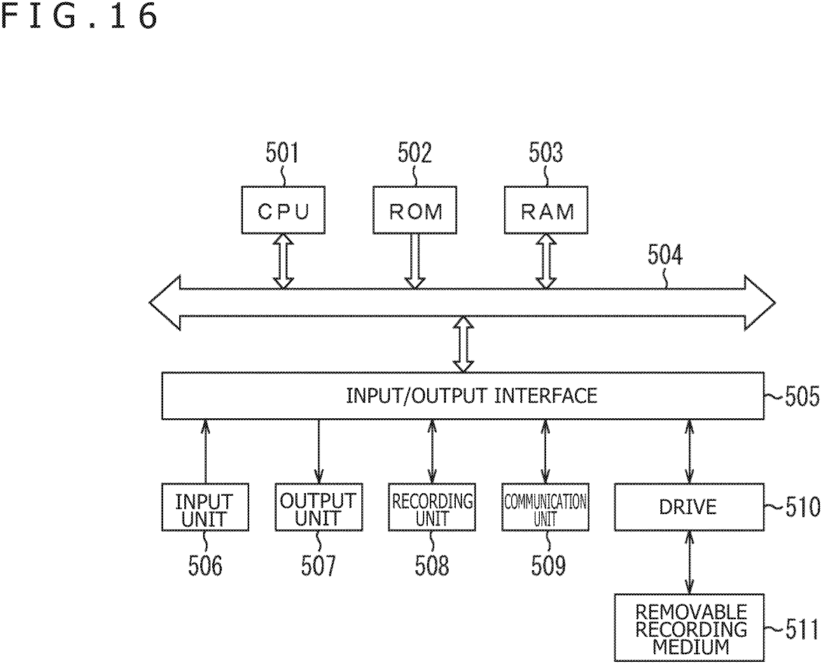

FIG. 16 is a block view that illustrates an example of a configuration of hardware for a computer that uses a program to execute the series of processing described above.

In the computer, a CPU (Central Processing Unit) 501, a ROM (Read Only Memory) 502, and a RAM (Random Access Memory) 503 are mutually connected by a bus 504.

An input/output interface 505 is also connected to the bus 504. An input unit 506, an output unit 507, a recording unit 508, a communication unit 509, and a drive 510 are connected to the input/output interface 505.

The input unit 506 includes a keyboard, a mouse, a microphone, an image capturing element, etc. The output unit 507 includes a display, a speaker, etc. The recording unit 508 includes a hard disk, a non-volatile memory, etc. The communication unit 509 includes a network interface, etc. The drive 510 drives a removable recording medium 511 which is a magnetic disk, an optical disk, a magneto-optical disk, a semiconductor memory, etc.

In a computer configured as above, the CPU 501, for example, loads a program recorded in the recording unit 508 into the RAM 503 via the input/output interface 505 and the bus 504, and executes the program, whereby the series of processing described above is performed.

A program executed by the computer (CPU 501), for example, can be provided by being recorded on the removable recording medium 511 which corresponds to package media, etc. In addition, the program can be provided via a wired or wireless transmission medium, such as a local area network, the internet, or digital satellite broadcasting.

In the computer, the removable recording medium 511 is mounted into the drive 510, whereby the program can be installed into the recording unit 508 via the input/output interface 505. In addition, the program can be received by the communication unit 509 via a wired or wireless transmission medium, and installed into the recording unit 508. In addition, the program can be installed in advance onto the ROM 502 or the recording unit 508.

Note that a program executed by a computer may be a program in which processing is performed in time series following the order described in the present specification, or may be a program in which processing is performed in parallel or at a necessary timing such as when a call is performed.

In addition, embodiments of the present technique are not limited to the embodiments described above, and various modifications are possible in a range that does not deviate from the substance of the present technique.

For example, the present technique can have a cloud computing configuration in which one function is shared among a plurality of apparatuses via a network, and processing is performed jointly.

In addition, each step described in the above-described flow charts can be shared among and executed by a plurality of apparatuses, in addition to being executed by one apparatus.

Furthermore, in a case where a plurality of instances of processing is included in one step, the plurality of instances of processing included in the one step can be shared among and executed by a plurality of apparatuses, in addition to being executed by one apparatus.

Furthermore, the present technique can have the following configurations.

(1) A signal processing apparatus including:
an obtainment unit that obtains a first audio signal, first band expansion information for band expansion of the first audio signal, and second band expansion information for band expansion of a second audio signal obtained by performing predetermined signal processing on the first audio signal;
a selection unit that selects which of the first band expansion information and the second band expansion information to perform band expansion on the basis of; and
a band expansion unit that, on the basis of the selected first band expansion information or second band expansion information and the first audio signal or the second audio signal, performs band expansion and generates a third audio signal.

The signal processing apparatus according to (1), in which the selection unit, on the basis of at least any one of a computational resource belonging to the signal processing apparatus, an amount of power consumption for the signal processing apparatus, a remaining amount of power for the signal processing apparatus, and a content reproduction time period based on the third audio signal, selects which of the first band expansion information and the second band expansion information to perform band expansion on the basis of.

The signal processing apparatus according to (1) or (2), in which
the first audio signal includes an object signal for object audio, and
the predetermined signal processing includes at least one of rendering processing with respect to a virtual speaker, or virtualization processing.

The signal processing apparatus according to (3), in which

the second audio signal includes a virtual speaker signal that is obtained by the rendering processing and is for the virtual speaker, or a drive signal that is obtained by the virtualization processing and is for a reproduction apparatus.

The signal processing apparatus according to (4), in which

the reproduction apparatus includes a speaker or headphones.

The signal processing apparatus according to (4) or (5), in which

the second band expansion information is high-range information regarding a virtual speaker signal that corresponds to the virtual speaker signal and has a higher sampling frequency than the virtual speaker signal or is high-range information regarding a drive signal that corresponds to the drive signal and has a higher sampling frequency than the drive signal.

The signal processing apparatus according to any one of (1) to (6), in which

the first band expansion information is high-range information regarding an audio signal that corresponds to the first audio signal and has a higher sampling frequency than the first audio signal.

The signal processing apparatus according to any one of (1) to (5), further including:

a signal processing unit that performs the predetermined signal processing.

The signal processing apparatus according to (8), further including:
a band limiting unit that performs band limiting on the first audio signal,
in which the signal processing unit performs the predetermined signal processing on an audio signal obtained due to the band limiting.

The signal processing apparatus according to (9), in which

the obtainment unit generates the second band expansion information on the basis of the first audio signal.

A signal processing method including:
a signal processing apparatus;
obtaining a first audio signal, first band expansion information for band expansion of the first audio signal, and second band expansion information for band expansion of a second audio signal obtained by performing predetermined signal processing on the first audio signal;
selecting which of the first band expansion information and the second band expansion information to perform band expansion on the basis of; and
on the basis of the selected first band expansion information or second band expansion information and the first audio signal or the second audio signal, performing band expansion and generating a third audio signal.

A program for causing a computer to execute processing including the steps of:
obtaining a first audio signal, first band expansion information for band expansion of the first audio signal, and second band expansion information for band expansion of a second audio signal obtained by performing predetermined signal processing on the first audio signal;
selecting which of the first band expansion information and the second band expansion information to perform band expansion on the basis of; and
on the basis of the selected first band expansion information or second band expansion information and the first audio signal or the second audio signal, performing band expansion and generating a third audio signal.

REFERENCE SIGNS LIST

| | |
|---|---|
| 11 | Decoding processing unit |
| 12 | Rendring processing unit |
| 13 | Virtualization processing unit |
| 41 | Band expansion unit |
| 71 | Signal processing apparatus |
| 201 | Encoder |
| 211 | Object position information encoding unit |
| 214 | Object high-range information calculation unit |
| 216 | Speaker high-range information calculation unit |
| 218 | Reproduction apparatus high-range information calculation unit |
| 261 | Selection unit |
| 281 | Band limiting unit |

1] A signal processing apparatus comprising:
an obtainment unit that obtains a first audio signal, first band expansion information for band expansion of the first audio signal, and second band expansion information for band expansion of a second audio signal obtained by performing predetermined signal processing on the first audio signal;
a selection unit that selects which of the first band expansion information and the second band expansion information to perform band expansion on a basis of; and
a band expansion unit that, on a basis of the selected first band expansion information or second band expansion information and the first audio signal or the second audio signal, performs band expansion and generates a third audio signal.

2] The signal processing apparatus according to claim 1, wherein
the selection unit, on a basis of at least any one of a computational resource belonging to the signal processing apparatus, an amount of power consumption for the signal processing apparatus, a remaining amount of power for the signal processing apparatus, and a content reproduction time period based on the third audio signal, selects which of the first band expansion information and the second band expansion information to perform band expansion on a basis of.

3] The signal processing apparatus according to claim 1, wherein
the first audio signal includes an object signal for object audio, and
the predetermined signal processing includes at least one of rendering processing with respect to a virtual speaker, or virtualization processing.

4] The signal processing apparatus according to claim 3, wherein
the second audio signal includes a virtual speaker signal that is obtained by the rendering processing and is for the virtual speaker, or a drive signal that is obtained by the virtualization processing and is for a reproduction apparatus.

5] The signal processing apparatus according to claim 4, wherein
the reproduction apparatus includes a speaker or headphones.

6] The signal processing apparatus according to claim 4, wherein
the second band expansion information is high-range information regarding a virtual speaker signal that corresponds to the virtual speaker signal and has a higher sampling frequency than the virtual speaker signal or is high-range information regarding a drive signal that corresponds to the drive signal and has a higher sampling frequency than the drive signal.

7] The signal processing apparatus according to claim 1, wherein
the first band expansion information is high-range information regarding an audio signal that corresponds to the first audio signal and has a higher sampling frequency than the first audio signal.

8] The signal processing apparatus according to claim 1, further comprising:
a signal processing unit that performs the predetermined signal processing.

9] The signal processing apparatus according to claim 8, further comprising:
a band limiting unit that performs band limiting on the first audio signal,
wherein the signal processing unit performs the predetermined signal processing on an audio signal obtained due to the band limiting.

10] The signal processing apparatus according to claim 9, wherein
the obtainment unit generates the second band expansion information on a basis of the first audio signal.

11] A signal processing method comprising, by a signal processing apparatus:
obtaining a first audio signal, first band expansion information for band expansion of the first audio signal, and second band expansion information for band expansion of a second audio signal obtained by performing predetermined signal processing on the first audio signal;
selecting which of the first band expansion information and the second band expansion information to perform band expansion on a basis of; and
on a basis of the selected first band expansion information or second band expansion information and the first audio signal or the second audio signal, performing band expansion and generating a third audio signal.

12] A program for causing a computer to execute processing including the steps of:
obtaining a first audio signal, first band expansion information for band expansion of the first audio signal, and second band expansion information for band expansion of a second audio signal obtained by performing predetermined signal processing on the first audio signal;
selecting which of the first band expansion information and the second band expansion information to perform band expansion on a basis of; and
on a basis of the selected first band expansion information or second band expansion information and the first audio signal or the second audio signal, performing band expansion and generating a third audio signal.
